(19) United States
(12) Patent Application Publication
(10) Pub. No.: US 2020/0079000 A1
(43) Pub. Date: Mar. 12, 2020

(54) A METHOD FOR MAKING SHEET LAMINATES FOR BEING PRE-PUNCHED TO A SHEET LID TO BE ATTACHED TO A CONTAINER

(71) Applicant: Danapak Fiexibles A/S, Slagelse (DK)

(72) Inventors: Steen Midtiby, Odense C (DK); Torben Fogtmann, Nyborg (DK); Peter Johansen, Odense C (DK)

(21) Appl. No.: 16/613,513

(22) PCT Filed: May 24, 2018
(86) PCT No.: PCT/EP2018/063678

§ 371 Date: Nov. 14, 2019

(30) Foreign Application Priority Data
May 24, 2017 (DK) PA 2017 70368
May 24, 2017 (EP) 17172648.2

(51) Int. Cl. B29C 48/00; B29C 48/154; B65D 77/20

(52) U.S. Cl. CPC B29C 48/0022; B29C 48/154; B29K 2025/06; B65D 77/2024; B29C 48/022

(57) ABSTRACT

A method for making a sheet laminate for being pre-punched to a sheet lid for a container, comprising the steps of providing a base sheet layer, and coextrusion coating an additional sheet layer, which comprises a tie layer comprising polyolefin and a welding layer comprising polystyrene (PS), onto said base sheet layer, so that the tie layer is disposed between the base sheet layer and the welding layer. The additional layer is coextrusion coated onto the base sheet layer. A sheet lid with a similar structure may be manufactured by punching the sheet laminate. The sheet lid may be used to close a container to form a package.

### CROSS-REFERENCE TO RELATED APPLICATIONS

The present application is a national phase entry under 35 U.S.C. § 371 of PCT/EP2018/063678, filed 24 May 2018, entitled “A METHOD FOR MAKING SHEET LAMINATES FOR BEING PRE-PUNCHED TO A SHEET LID TO BE ATTACHED TO A CONTAINER.” The present application claims the benefit of Danish Patent Application No. PA 2017 70368, filed 24 May 2017, entitled “A METHOD FOR MAKING A SHEET LAMINATE FOR BEING PRE-PUNCHED TO A SHEET LID FOR A CONTAINER,” and European Patent application No. 17172648.2, filed 24 May 2017, entitled “A METHOD FOR MAKING A SHEET LAMINATE FOR BEING PRE-PUNCHED TO A SHEET LID FOR A CONTAINER.” Each of these applications is incorporated by reference herein for all purposes.

### BACKGROUND

The present disclosure relates to methods for making sheet laminates for being pre-punched to sheet lids to be attached to containers, specifically either polystyrene (PS) containers or containers comprising a PS attachment surface, to produce packages. This disclosure also relates to methods for making a sheet lid, to sheet laminates, to sheet lids, and to packages.

In the field of packaging, polystyrene (PS) is commonly used today for manufacture of thermoformed foodstuff containers or cups, e.g. for yoghurt and other dairy products, fruit juices, drinking water, salads, pâtés, etc. The PS containers may be of expanded PS (EPS). PS has the advantage that it is easy to thermoform from films in both inline and non-inline manufacture, typically in thicknesses from 200 to 2500 μm. However, PS has relatively poor oxygen and water vapour barrier properties and has a tendency to transfer taste to the packaged product over time. But since many foodstuff products, such as dairy products, usually have a short shelf life, these lacking properties are often of no significant disadvantage in packaging of such products.

Such PS containers or cups comprise an open top, which is closed and sealed using a sheet lid. The PS containers are closed off and sealed with the sheet lid after dosing of the foodstuff product into the container, which produces a package comprising the container, the foodstuff product in the container, and the sealing lid.

Today, such sheet lids for PS containers commonly comprise an aluminium (Al) sheet, to which a layer of welding lacquer has been applied in order for it to be able to adhere to the container using welding during manufacture of the package. The welding lacquer may comprise PS. The welding layer typically has a thickness corresponding to a planar distribution of 5 to 9 g/m². This type of lid typically suffers from inadequate tear strength which can result in the lid tearing when being opened instead of separating at the welded contact surface between the lid and the container (the welding area). The user then often positions a finger on an underside of the lid to fully open the product. A film or parts of the foodstuff product is often located on this underside so that the user may get some of the foodstuff product on the finger, which is of course a nuisance to the user. Use of Al in packaging also generally has known environmental drawbacks. An advantage of Al is that it has good barrier properties, but since the barrier properties of the PS container are usually poor, this provides no real advantage when an Al based lid is applied to PS containers. A general drawback of the use of welding lacquer is that it requires large amounts of energy to drying. Furthermore, appliance of welding lacquer may be cumbersome and expensive, especially if the welding lacquer is only applied along a rim of the lid to improve lid transparency. Also, welding lacquer typically has a limited welding strength (usually about 5-7 N per 15 mm) and the welding is adhesive, so that the lid parts or delaminates too easily at the welding surface so that the seal may be broken due to a creeping effect in the welding zone; for example if the package is pressurized. Pressurization occurs regularly with packaged foodstuffs, e.g. certain types of yoghurt that are packaged in a slightly heated state or after packaging are heated to about 30 to 50° C. to stimulate bacteria growth.

Another prior art lid for PS containers alleviates the drawbacks associated with poor tear strength of the lid. This lid comprises a polyethylene terephtalate (PET) sheet to which an extruded layer of welding lacquer has been applied in order for it to be able to adhere to the container using welding. The welding layer typically has a thickness corresponding to a planar distribution of 5 to 9 g/m². This lid structure typically provides much improved tear strength so that the lid delaminates in the welding layer as desired. However, the above described drawbacks related to use of welding lacquer also apply to this type of lid.

A third type of sheet lid is punched or cut from a flexible sheet laminate and is commonly used today as lids for foodstuff containers. The lid may comprise a large variety of various materials and compounds, including a range of polymers. Such lids may have many advantages, especially if using an extruded welding layer that has been applied to a base sheet layer so that the welding layer is distributed on an entire surface of the sheet laminate and sheet lid. This means that it is not necessary to apply a relatively thick expensive welding lacquer layer along a rim of the lid, making manufacture simpler, easier, less expensive and more environmentally friendly. The lid can be punched anywhere along its planar extent and in any shape to be weldable to any shape of a container.

One example of such a sheet lid that may be pre-punched is disclosed in applicant's WO 2013/075713 A1, which discloses a sheet lid comprising a PET base sheet layer coated with an additional sheet layer on the base sheet layer, the additional layer comprising a polyolefin layer and an amorphous PET welding layer, the additional layer being coextrusion coated onto the base sheet layer, the polyolefin layer being disposed between the base sheet layer and the welding layer. This sheet lid has many advantages, but is not suitable for containers of PS or comprising a PS welding surface since the welding layer does not weld against PS.

Another example is disclosed in applicant's WO 2011/160627 A1, which discloses a sheet laminate lid comprising a PET base sheet layer coated with an additional sheet layer on the base sheet layer, the additional sheet layer comprising a polyolefin layer and a polypropylene (PP) welding layer, which are coextrusion coated onto the base sheet layer, the polyolefin layer being disposed between the base sheet layer and the welding layer. This sheet laminate lid also has many advantages, but similarly does not weld against containers of PS.

Both of the above latter sheet laminate lids apply coextrusion coating. Extrusion coating is a known process where a carrier foil or base sheet layer is moved between two rollers, a cooling roller and a counter roller, respectively. An additional layer, specifically a thermoplastic polymeric melt, is applied between the foil and the cooling roller in a continuous process. Upon contact with the cooling roller, the melt solidifies, and upon contact with the carrier foil, the thermoplastic melt is adhered to the carrier foil. The result is a carrier foil coated with a thin layer of a thermoplastic material. Coextrusion is a process of extruding two or more materials through a single die of an extruder so that the extrudates merge and weld together into a laminar structure before chilling or quenching. Coextrusion can be employed in film blowing, free film extrusion, and extrusion coating processes, the latter being referred to as coextrusion coating. In coextrusion coating the two or more coextruded melts are extruded together from one common die and while still not having been chilled are coated onto the base sheet layer or carrier foil so that the coextruded additional layer adheres to the base sheet layer. A primer may be applied to the base sheet layer before the coextruded melt is applied to it in order to improve adherence.

Today, PS is only to a very limited degree used in flexible packaging and, if used at all, usually only in the form of single layer PS film produced using film blowing or cast extrusion, typically at temperatures of 200 to 250° C. This is due to PS' relatively poor barrier properties, its tendency to transfer taste to the packaged product and its relatively poor weldability against itself compared to, for example, polyethylene (PE). PS single layer films find some application for example as separation between slices of cheese due to the relatively limited tendency of PS films to adhere to protein-containing products.

Today, PS is thus not used in sheet laminate lids. However, it would be desirable to provide a sheet laminate lid, which were weldable to a PS container and which could be used as a pre-punched lid. One reason for not using a PS welding layer is that a person skilled in the art would expect such a lid to have large curl, i.e. a tendency to roll up upon itself. Sheet laminate lids with large curl are not desirable for pre-punched lids, i.e. sheet lids that are punched or cut before attachment to the container to be closed, since curling makes it difficult or impossible to handle, store and attach the lids to containers. For example, packaging in a normal packaging machine is not possible with pre-punched sheet lids having large curl since it is not possible to handle them in the machine when they roll up upon themselves. Another reason is that the temperatures used in extrusion coating, i.e. for making an extrusion melt adhere to a base sheet layer, must, as generally recognized in the art and especially for polymer types used in coextrusion coated welding layers, such as polypropylene (PP), polyester and polyethylene (PE), be significantly higher than for producing a PS film (e.g. in an extrusion process) since, otherwise, e.g. the adherence of the coextrusion coating will be insufficient. This temperature is so high (typically at least 275° C.) that it is expected that gases will form in the PS and produce unwanted bubbles or even holes in the extrusion melt and thus in the resultant PS layer (see e.g. Plastic Films: Technology and Packaging Applications, Jenkins/Osborn 1992; and Extrusion Coating Manual, 4^{th} edition, Bezigian 1999). Also, due to the high temperature of the melt, the PS is expected to decompose or degrade, and burns may form in the PS due to the high temperature of gases produced in the melt. Welding layers are typically manufactured to be relatively thin, and the burns are especially pronounced in the case of thin PS layers extruded at high temperatures.

### SUMMARY

On this background it may be an object of the sheet laminates according to this disclosure to provide a sheet laminate from which a sheet lid may be punched, and specifically used as a pre-punched lid, the sheet laminate being weldable to a PS container or a container with a welding surface comprising PS, specifically so as to have a suitably high welding strength. Another object may be to provide such a sheet laminate which results in sheet lids with reduced or substantially no curl. Another object may be to provide such a sheet laminate which from which a sheet lid may suitably be pre-punched. Another object may be to provide a sheet laminate or a sheet lid, which has improved peelability. Another object may be to provide a sheet laminate or a sheet lid, which has good barrier properties, tear strength and/or welding strength.

These and further objects may be arrived at by the methods according to the present disclosure. One such method is for making a sheet laminate for being pre-punched to a sheet lid for a container, the method comprising the steps of:
providing a base sheet layer, and
coextrusion coating an additional sheet layer, which comprises a tie layer comprising polyolefin and a welding layer comprising polystyrene (PS), onto said base sheet layer, so that the tie layer is disposed between the base sheet layer and the welding layer.

The inventors have surprisingly found that a sheet laminate may advantageously be manufactured using a coextrusion coating step, which sheet laminate may be punched and applied as a pre-punched lid for a container, specifically due to small curl of the lid, which lid can be welded to a thermoformed PS container or a container with a PS welding surface. More specifically, the inventors have found that it is possible to successfully manufacture a sheet laminate with good properties by keeping the temperature of the PS welding layer material relatively low (compared to the expected necessary extrusion coating temperature) during the entire extrusion coating process, specifically at a temperature of the PS melt of less than 275° C. and even as low as 200° C. or lower. Hereby, the expected problems associated with production of gases, degradation of material and burns in the PS welding layer can surprisingly largely be avoided.

The temperature of the PS welding layer and/or the tie layer material may be held relatively low in one or more initial steps of the extrusion coating process and then raised somewhat before or when the welding layer melt comes into contact with the tie layer melt during the coextrusion of the two layers, and then only to a still relatively low temperature, specifically lower than 275° C. or as low as 200° C. or lower.

The potentially achieved reduced curl of the sheet laminate and lid is believed to be due to the coextrusion coating process according to this disclosure that, as explained above, is surprisingly possible. Due to the small curl of a lid manufactured from the sheet laminate, the sheet laminates according to this disclosure are suitable for being pre-punched to sheet lids, i.e. punching or cutting before attachment to a container to be closed.

Suitably strong adhesion may be achieved between a container of PS or comprising a PS welding surface and the welding layer since the welding layer produced according to this disclosure welds suitably well to PS or materials comprising PS. Additionally, a split peel may be achieved during peeling off of a lid manufactured from the sheet laminate, i.e. the welding layer will remain on the container while a controlled delamination occurs between the tie layer and the welding layer. This split peel occurs substantially only in a welding zone, i.e. the zone of the lid where the lid has been welded to the container. This means that a controlled and well-defined opening of a package closed with the lid may be achieved, avoiding tearing or destroying the lid. The force required and/or desired to delaminate will typically be 5 to 12 N per 15 mm, but may be lower depending on the desired purpose of the sheet laminate or lid. This force can be varied by varying the thickness of the welding layer. However, to avoid curl, the thickness of the welding layer should preferably be kept small.

The suitably strong adhesion of the welding layer also means that a sheet lid manufactured of the sheet laminate will be less sensitive to pressurization of the container so that the resultant packaging may, for example, be used for yoghurt that is heated to stimulate bacteria growth.

Due to the step of coextrusion coating, the sheet laminate will be stronger than a corresponding sheet laminate with a base sheet layer provided with welding lacquer, thereby allowing the thickness of the base sheet layer to be reduced correspondingly, which may achieve saving of weight and material of 15% or more compared to a comparable sheet laminate using welding lacquer.

Additionally, with the methods according to this disclosure a sheet laminate with good barrier properties can be manufactured at surprisingly low cost.

One purpose of the tie layer is to promote adherence between the welding layer and the base sheet layer. Two or more tie layers or each tie layer may be formed in the coextrusion coating process, wherein the layer, which is adjacent to the base sheet layer, provides adherence to the base sheet layer and the layer which is adjacent to the welding layer provides adherence to the welding layer. Similarly, the two tie layers may adhere to each other.

All layers may be distributed to have substantially uniform thickness or planar weight across substantially an entire planar extent of the sheet.

The base sheet layer of the sheet laminate has a first major surface which faces the tie layer and an opposite second major surface, which second major surface may be an outer major surface for facing the environment when a lid has been punched from the sheet laminate. It is noted that the base sheet layer may comprise further layers such as a metallized layer, a barrier coating and/or a protection layer forming part of the base sheet layer. These layers may be provided on either one of the two major surfaces of the base sheet layer. The base sheet layer with the optional metallized layer, barrier coating and/or protection layer may be manufactured in a first, separate process before the additional layer of the sheet laminate is coextrusion coated thereon.

The base sheet layer may comprise or essentially consist of polyester, specifically polyethylene terephtalate (PET), more specifically oriented, potentially biaxially oriented, PET (OPET), or can be a film comprising or essentially consisting of Al. The base sheet layer may be a separately extruded or coextruded layer.

The thickness of the base sheet layer, specifically in the case where it comprises or essentially consists of PET or OPET, may be between 20 and 50 μm, preferably between 30 and 40 μm, and more preferred between 34 and 38 μm.

The thickness of the welding layer and/or the tie layer may be less than 50 μm, preferably less than 45 μm, more preferred less than 40 μm, more preferred equal to or less than 35, 30 or 25 μm. The thickness of the tie layer and/or welding layer is preferably above 2, 3, 4 or 5 μm.

The accumulated thickness of the additional layer may be equal to or less than 50 μm, preferably equal to or less than 45 μm, more preferred equal to or less than 40, 35, 30, 25, 20, 15 or 13 μm, and/or the area distribution thereof may be equal to or less than 50 g/m², preferably equal to or less than 45 g/m², more preferred equal to or less than 40, 35, 30, 25, 20, 15 or 13 g/m². This thickness is preferably equal to or above 2, 3, 4, 5, 6, 7, 8, 9, 10 or 11 μm, and/or the area distribution thereof is preferably equal to or above 2, 3, 4, 5, 6, 7, 8, 9, 10 or 11 g/m². The presently preferred thickness is about 12 μm or distribution about 12 g/m².

The thickness of the PS welding layer may be equal to or less than 10 μm, preferably equal to or less than 8 μm, more preferred equal to or less than 7, 6, 5 or 4 μm, and/or the area distribution thereof may be equal to or less than 10 g/m², preferably equal to or less than 8 g/m², more preferred equal to or less than 7, 6, 5 or 4 g/m². This thickness is preferably equal to or above 0.5, 1 or 2 μm, and/or the area distribution thereof is preferably equal to or above 0.5, 1 or 2 g/m². The presently preferred thickness is about 3 μm or distribution about 3 g/m². It has been shown that low or no curling of a lid pre-punched from a sheet may be achieved with a welding layer of such low thickness while still achieving suitably strong welding properties.

The thickness of the tie layer, in case only a single tie layer is present, may be equal to or less than 20 μm, preferably equal to or less than 18 μm, more preferred equal to or less than 16, 14, 13, 12, 11 or 10 μm, and/or the area distribution thereof may be equal to or less than 20 g/m², preferably equal to or less than 18 g/m², more preferred equal to or less than 16, 14, 13, 12, 11 or 10 g/m². This thickness is preferably equal to or above 4, 5, 6, 7 or 8 μm, and/or the area distribution thereof is preferably equal to or above 4, 5, 6, 7 or 8 g/m². The presently preferred thickness is about 9 μm or distribution about 9 g/m².

In case two tie layers are present, the thickness of the tie layer facing the base sheet layer may be equal to or less than 10 μm, preferably equal to or less than 9 μm, more preferred equal to or less than 8, 7, 6, 5, or 4 μm, and/or the area distribution thereof may be equal to or less than 10 g/m², preferably equal to or less than 8 g/m², more preferred equal to or less than 8, 7, 6, 5, or 4 g/m². This thickness is preferably equal to or above 0.5, 1 or 2 μm, and/or the area distribution thereof is preferably equal to or above 0.5, 1 or 2 g/m². The presently preferred thickness is about 3 μm or distribution about 3 g/m².

In case two tie layers are present, the thickness of the tie layer facing the welding layer may be equal to or less than 15 μm, preferably equal to or less than 13 μm, more preferred equal to or less than 12, 11, 10, 9, 8 or 7 μm, and/or the area distribution thereof may be equal to or less than 15 g/m², preferably equal to or less than 13 g/m², more preferred equal to or less than 12, 11, 10, 9, 8 or 7 g/m². This thickness is preferably equal to or above 2, 3, 4 or 5 μm, and/or the area distribution thereof is preferably equal to or above 2, 3, 4 or 5 g/m². The presently preferred thickness is about 6 μm or distribution about 6 g/m².

A sheet laminate manufactured according to this disclosure with such layer thicknesses and potentially without further barrier layers typically has a satisfactory water vapour transmission rate for use in many or all of the above-mentioned applications, typically in a range of 0.01 to 15 g/m²/24 h (measured according to the standard ASTM F1249, 38° C., 90% RH).

An extrusion primer may be applied to the base sheet layer between the base sheet layer and the tie layer, specifically before the coating step. The primer may be applied to the base sheet layer immediately before, i.e. 0 to 20, 1 to 10 or 2 to 7 seconds before, the step of coextrusion coating. In some embodiments, no primer is present. By choosing proper compositions of the layers, the sheet laminate may be manufactured with sufficient adhesion between the layers without the need for additional layers such as primer layers. Especially in case the base sheet layer is not a metal layer, or where the base sheet layer is not metallized on the surface facing the tie layer, i.e. where the surface is e.g. polyester, it may be preferable to apply a primer on the surface of the base sheet layer facing the adjacent tie layer before extrusion coating of the additional layer in order to improve adherence of the base sheet layer to the adjacent tie layer.

Especially in the case where the base sheet layer is a metal layer, such as of aluminium, or where the base sheet layer is metallized on the surface facing the tie layer(s), it may not be necessary to apply a primer on the surface of the base sheet layer facing the adjacent tie layer since adherence to the base sheet layer to the adjacent tie layer will typically be satisfactory. Thus, the tie layer may be positioned to coincide directly with, e.g. directly with the PET or OPET of, the base sheet layer.

A primer layer, of which use is thus especially relevant for non-metallic surfaces, may essentially consist of a substantially water soluble or a substantially water insoluble primer and may be selected from the group consisting of:
a polyurethane (PU) based primer, preferably with reactive isocyanate groups,
a polyurethane/polyvinyl buthylene (PvB) based primer,
a polyurethane/nitrocellulose (NC) based primer,
a hotmelt primer based on UV hardening technology,
a polyethylenimine based primer or
a combination of the above.

Other primer types may also be suitable.

During manufacture, the primer layer may be applied directly onto said first major surface, the additional sheet layer subsequently being coated directly onto the primer.

The primer may be solvent-based, so as to be non-soluble in water, or water-based.

It should be taken into consideration that the potentially high barrier properties of the base sheet layer and the additional sheet layer may lead to accumulation of water, which may negatively influence especially the adhesiveness of the primer, potentially leading to the adjacent layers unintentionally being released.

The enhanced adhesion between the base sheet layer and the additional layer achieved by using a primer layer may allow delamination to be controlled during opening of a package with a sheet lid punched from a sheet laminate according to this disclosure.

One or all of the starting materials of the additional layer may be in the form of or comprise granulate or granules.

The base sheet layer may comprise at least 50% by weight of polyester, PET, OPET or aluminium, preferably at least 60, 70, 80, 90 or 95% by weight or substantially 100% by weight. The base sheet layer may comprise small amounts or residues of additional materials such as anti-block agents, release agents and the like. The base sheet layer may comprise a colouring agent and may be white or another colour. The base sheet layer may comprise one or more colouring agents to make the resultant sheet lid non-transparent or opaque, which is especially relevant in case the sheet laminate is used for packaging of dairy products, such as yoghurt, where a thin film of the dairy product will often adhere to a bottom surface of the sheet lid, making transparency undesirable for aesthetic reasons.

As mentioned above, the base sheet layer may comprise further layers such as a barrier coating or metallization. The barrier coating may comprise or essentially consist of polyvinylidene chloride (PVdC) and/or a ceramic barrier material, the latter potentially being selected from the group consisting of aluminium oxide (AlOx), silicon oxide (SiOx), magnesium oxide, cerium oxide, hafnium oxide, tantalum oxide, titanium oxide, yttrium oxide, zirconium oxide and mixtures thereof.

As also mentioned above, the base sheet layer may be metallized, potentially on its second major surface facing away from the tie layer, in which case the metal layer is exposed and preferably provided with an outer protective lacquer to prevent the metal layer from being scratched or damaged. Alternatively, the metal layer can be disposed on the first major surface of the base sheet layer between the base sheet layer and the additional sheet layer, in which case the tie layer and/or primer may have sufficient adherence so as to avoid undesired delaminating of the sheet laminate. The polyvinylidene chloride barrier coating or ceramic barrier coating may have a thickness of less than 1.5 μm, preferably less than 1.2 μm, more preferred less than 1 μm, and preferably of more than 0.05 μm, more preferred more than 0.5 μm. With a barrier coating thickness of less than 1 μm an oxygen transmission rate of the sheet laminate of less than 3 cm³/m²/24 h/bar can be achieved. Similarly, a water vapour transmission rate of less than 3 g/m²/24 h can be achieved.

The primer materials mentioned herein are specifically suitable for being applied to the barrier materials mentioned above, i.e. polyvinylidene chloride barrier coating and ceramic barrier coating.

No further layer(s) need be provided on the base sheet layer top major surface. No further layer(s) need be provided beneath the welding layer, i.e. on a bottom surface of the welding layer. In some embodiments, no further layers are included in the sheet laminate besides the base sheet layer and the additional layer, and in some embodiments the additional layer only comprises at least one tie layer, such as one or two tie layers, and the welding layer. In some embodiments the tie layer or each of the tie layers and the welding layer are only one single layer, i.e. they comprise no sublayers. Preferably, the additional layer comprises only the tie layer(s) and the welding layer, but other layers may be present, such layers potentially being coextrusion coated together with the tie layer(s) and the welding layer. In some embodiments, only materials for providing an improved adhesion are provided between the layers of the sheet laminate.

The base sheet layer and/or the additional layer and/or the tie layer(s) and/or the welding layer and/or the sheet laminate may be transparent and/or translucent and/or may allow at least 10%, 25%, 50%, 60%, 70%, 80%, 90%, 95% or substantially 100% of visible light to pass through. Alternatively, the base sheet layer and/or the tie layer(s) and/or the sheet laminate may be opaque, i.e. allowing substantially no visible light transmission through it. In the context of the present specification the term “transparent” is intended to mean that when the sheet laminate is applied as a lid of a container, it has an optical transparency high enough to allow the contents of the resultant package to be visually inspected when the product is presented in normal light conditions, such as on a shelf in a supermarket.

The tie layer may comprise at least 50% by weight polyolefin, preferably at least 60, 70, 80, 90 or 95% by weight or substantially 100% by weight. A polyolefin may be defined as the class of polymers produced from a simple olefin (also called an alkene with the general formula CₙH₂ₙ) as a monomer. For example, polyethylene (PE) is the polyolefin produced by polymerizing the olefin ethylene. Polypropylene (PP) is another common polyolefin which is made from the olefin propylene. The polyolefin may be, comprise or substantially consist of a thermoplastic polyolefin and/or a poly-α-olefin. The degrees of crystallinity of the polyolefin may be above 60%, 70%, 80% or 90%. The polyolefin may be, comprise or substantially consist of PE or may alternatively or additionally be, comprise or consist of PP. The polyolefin, including e.g. PE and/or PP, may be in the form of a homo-polymer or a co-polymer of the polyolefin.

The tie layer may be, comprise or consist of a PE containing acrylate or methyl acrylate. The acrylate or methyl acrylate content may be equal to or above 10, 15 or 20 weight %. The tie layer may additionally or alternatively be, comprise or consist of a PE containing anhydride or maleic anhydride. The anhydride or maleic anhydride content may be equal to or above 0.1, 0.2 or 0.3 weight %. The tie layer may be, comprise or consist of a terpolymer of ethylene, acrylic ester and/or maleic anhydride. The melt index (190°/2.16 kg) of the tie layer may alternatively or additionally be 5 to 10 g/10 min measured according to the standard ISO 1133/ASTM 1238. The tie layer may be, comprise or consist of Lotader 4503 as marketed by Arkema in January 2015. The tie layer may be, comprise or consist of an ethylene vinyl acetate (EVA) and/or ethylene acrylic acid (EAA) and/or ethylene methacrylic acid (EMAA) and/or a copolymer or copolymer resin based on such materials, all potentially containing PE which materials are preferred in case of a metallized base sheet layer. The tie layer may be, comprise or consist of an EMAA, the methacrylic acid content or methacrylic acid comonomer content of 3 to 10, 4 to 9, 5 to 8, 6 to 7 or about 6.5 wt %, such as Nucrel® 0609HSA as marketed by DuPont as of July 2010. The tie layer may be a mixture of the above examples. The tie layer may be a single tie layer, i.e. no further tie layers being present.

In case two tie layers are present, it is preferred that the tie layer adjacent the welding layer is, comprises or consists of an EVA, specifically an EVA copolymer resin, such as marketed by ExxonMobil under the trade name Escorene™ Ultra UL 00728EL, and that the tie layer adjacent the base layer is, comprises or consists of an EAA, specifically an EAA or EMAA copolymer resin, such as marketed by ExxonMobil under the trade name Escor™ 5110. The vinyl acetate content of a tie layer comprising EVA or of the EVA of such tie layer may be 20 to 40 or 25 to 30 wt %, the ethylene content potentially making up substantially the remaining parts of the material, i.e. 60 to 80 or 70 to 85 wt %. The acrylic acid content of a tie layer comprising EAA or of the EAA of such tie layer may be 5 to 15 or 9 to 13 wt %. This may provide sufficient adhesion of the respective layers to each other.

Alternatively, the tie layer adjacent the welding layer is, comprises or consists of a PE containing acrylate or methyl acrylate as mentioned above, and the tie layer adjacent the base layer is, comprises or consists of an EAA or EMAA copolymer resin as mentioned above.

The welding layer may comprise at least 50% by weight PS, preferably at least 60, 70, 80, 90 or 95% by weight or substantially 100% by weight PS. The PS may comprise or essentially consist of high impact PS (HIPS) or general purpose PS (GPPS) or a mixture thereof.

Generally, two or more tie layers may be included. Especially in the case of a metallized base sheet layer, it may be preferred to include two tie layers.

Any and all of the above options regarding compositions, thicknesses etc. of the different layers may be combined. The same goes for the embodiments described below, e.g. with regard to temperatures.

In an embodiment of the methods according to this disclosure for making a sheet laminate, a temperature of a welding layer material, the welding layer material being comprised in the welding layer in the sheet laminate, is kept at or below a temperature of 280, 279, 278, 277, 276, 275, 274, 273, 272, 271, 270, 269, 268, 267, 266, 265, 264, 263, 262, 261, 260, 259, 258, 257, 256, 255, 254, 253, 252, 251, 250, 249, 248, 247, 246, 245, 244, 243, 242, 241, 240, 235, 230 or 225° C. during all parts of the coextrusion coating step.

This temperature of the welding layer material is preferably equal to or above 200, 201, 202, 203, 204, 205, 206, 207, 208, 209, 210, 211, 212, 213, 214, 215, 216, 217, 218, 219, 220, 221, 222, 223, 224, 225, 226, 227, 228, 229 230, 231, 232, 233, 234, 235, 236, 237, 238, 239 or 240° C. and is preferably in an interval between 200 to 280, 220 to 275, 220 to 270, 225 TO 270, 230 to 270, 230 to 265, 235 to 265, 240 to 260, 235 to 255, 230 to 250, 240 to 250, 235 to 245, 237 to 243, 238 to 242 or 239 to 241° C., This temperature may advantageously be a minimum of 220, 225, 230, 235 or 240° C. and up to 280, 279, 278, 277, 276, 275, 274, 273, 272, 271, 270, 269, 268, 267, 266, 265, 264, 263, 262, 261, 260, 259, 258, 257, 256, 255, 254, 253, 252, 251, 250, 249, 248, 247, 246, 245, 244, 243, 242, or 241° C. It is presently preferred that this temperature is about 240 to 260° C.

A tie layer material resulting in the tie layer may be fed separately into a feed block of an extruder. In case two or more tie layers are applied, tie layer materials of each tie layer may be fed separately from each other and/or from the welding layer material.

Generally, in this specification, when terms such as “the tie layer material” and “the welding layer material” are used, such terms are meant to indicate the material that will eventually or ultimately form the respective layer in the sheet laminate that results from the methods according to this disclosure. Thus, for instance, the welding layer material is the initial material that is fed into an extruder, flows through the extruder and eventually is applied as the welding layer of the resultant sheet laminate. Such a layer material has a temperature before being fed, during feeding, in the different sequential zones inside the extruder, and when being coated together with the other layer(s) of the additional layer onto the base sheet layer. Such temperature may vary during the sequence of the coextrusion coating step, the temperature of different materials may vary differently and may be different from each other in the sequential steps and/or extruder zones during the extrusion coating step. The temperature of such a material may be a maximum temperature of any part or every part or substantially any or every part of the material, especially in case an upper range limit is defined, or a minimum temperature of any or every part or substantially any or every part of the material, especially in case a lower range limit is defined. Local temperature variations of a layer material may occur. In case a single temperature is defined, such temperature may be a mean or average temperature of all parts of the material.

The temperature of the welding layer material may be above a temperature of a tie layer material(s) at an entry into the feed block of an extruder with which the coextrusion coating is extruded, such as a temperature of equal to or less than 80, 75, 70 or 65° C. above a temperature of the tie layer material(s), and/or a temperature of equal to or more than 40, 45, 50 or 55° C. above a temperature of the tie layer material(s). In case two tie layers are used, this temperature for the tie layer adjacent the base sheet layer may be equal to or less than 60, 55, 50 or 45° C. above a temperature of the tie layer material(s), and/or a temperature of equal to or more than 20, 25, 30 or 35° C. above a temperature of the tie layer materials. Similarly, for the tie layer adjacent the welding layer this temperature may be equal to or less than 80, 75, 70 or 65° C. above a temperature of the tie layer material(s), and/or a temperature of equal to or more than 40, 45, 50 or 55° C. above a temperature of the tie layer material.

In another embodiment, a temperature of a tie layer material, the tie layer material being comprised in the tie layer adjacent the welding layer in the sheet laminate, is kept at or below a temperature of 280, 275, 270, 265, 260, 255, 250, 245, 240, 235, 230, 225 or 220° C. during all parts of the coextrusion coating step. Surprisingly, it is possible to achieve satisfactory results with such low tie layer material temperature even using a tie layer material comprising or consisting of an EVA, specifically an EVA copolymer resin, as mentioned above. The recommended temperatures of such tie layer materials and alternatives is typically above such temperatures.

In another embodiment, a temperature of a tie layer material, the tie layer material being comprised in the at least one tie layer of the sheet laminate, is kept at or below a temperature of 270, 265, 260, 255, 250, 245, 240, 235, 230, 225 or 220° C. during all parts of the coextrusion coating step.

In another embodiment, the coextrusion extrusion coating step is performed in an extruder, which comprises a feed zone, and in which feed zone a temperature of a tie layer material, the tie layer material being comprised in the at least one tie layer of the sheet laminate, is 110 to 170, preferably 115 to 165 or 120 to 160° C.

In another embodiment, the coextrusion extrusion coating step is performed in an extruder, which comprises a feed zone, and in which feed zone a temperature of a welding layer material, the welding layer material being comprised in the welding layer in the sheet laminate, is 160 to 215° C., preferably 165 to 210 or 170 to 205 or 175 to 200° C.

In another embodiment, the coextrusion extrusion coating step is performed in an extruder, which comprises a transition zone, and in which transition zone a temperature of a tie layer material, the tie layer material being comprised in the at least one tie layer of the sheet laminate, is 155 to 205, preferably 160 to 200 or 165 to 195 or 160 to 170° C.

In another embodiment, the coextrusion extrusion coating step is performed in an extruder, which comprises a transition zone, and in which transition zone a temperature of a welding layer material, the welding layer material being comprised in the welding layer in the sheet laminate, is 215 to 265° C., preferably 220 to 260 or 225 to 255 or 230 to 250° C.

In another embodiment, the coextrusion extrusion coating step is performed in an extruder, which comprises a metering/mixing zone, and in which metering/mixing zone a temperature of a tie layer material, the tie layer material being comprised in the at least one tie layer of the sheet laminate, is 205 to 255, preferably 210 to 250 or 215 to 245 or 220 to 240° C.

In another embodiment, the coextrusion extrusion coating step is performed in an extruder, which comprises a metering/mixing zone, and in which metering/mixing zone a temperature of a welding layer material, the welding layer material being comprised in the welding layer in the sheet laminate, is 225 to 275° C., preferably 230 to 270 or 235 to 265° C.

In another embodiment, the coextrusion extrusion coating step is performed in an extruder, which comprises a feed block with a feed block zone, and in which feed block zone a temperature of a tie layer material, the tie layer material being comprised in the at least one tie layer of the sheet laminate, is 225 to 275° C., preferably 230 to 270 or 235 to 265° C.

In another embodiment, the coextrusion extrusion coating step is performed in an extruder, which comprises a feed block with a feed block zone, and in which feed block zone a temperature of a welding layer material, the welding layer material being comprised in the welding layer in the sheet laminate, is 225 to 275° C., preferably 230 to 270 or 235 to 265° C.

In another embodiment, the coextrusion extrusion coating step is performed in an extruder, which comprises a feed block, a temperature of a welding layer material, the welding layer material being comprised in the welding layer in the sheet laminate, in the feed block being equal to or less than 10° C. from a temperature of a tie layer material in the die.

In another embodiment, the coextrusion extrusion coating step is performed in an extruder, which comprises a die, a temperature of a welding layer material, the welding layer material being comprised in the welding layer in the sheet laminate, in the die being equal to or less than 10° C. from a temperature of a tie layer material, the tie layer material being comprised in the at least one tie layer of the sheet laminate.

In any one or more of the above embodiments concerning a temperature of the tie layer material, in case the at least one tie layer comprises two or more tie layers, the designated temperatures of the tie layer material may apply to one or both or more than two or all of the tie layers.

In another embodiment, the coextrusion coating step is performed in an extruder, which comprises a feed zone, and in which feed zone a temperature of a tie layer material of a tie layer adjacent the welding layer is 115 to 160, preferably 115 to 155 or 115 to 155 or 115 to 150 or 115 to 145 or 115 to 1400/115 to 135 or 115 to 130 or 115 to 125 or 117 to 123° C., and/or a temperature of the welding layer material is 160 to 200° C., preferably 165 to 195, 170 to 190 or 175 to 185° C.

In another embodiment, the coextrusion coating step is performed in an extruder, which comprises a transition zone, and in which transition zone a temperature of a tie layer material of a tie layer adjacent the welding layer is 160 to 190, preferably 160 to 185 or 160 to 180 or 165 to 175° C., and/or a temperature of the welding layer material is 200 to 250° C., preferably 205 to 250 or 210 to 250 or 215 to 250 or 220 to 250 or 225 to 250 or 230 to 250 or 235 to 245° C.

In another embodiment, the coextrusion coating step is performed in an extruder, which comprises a metering/mixing zone, and in which metering/mixing zone a temperature of a tie layer material of a tie layer adjacent the welding layer is 170 to 260, preferably 175 to 255 or 180 to 250 or 185 to 245 or 190 to 240 or 195 to 235 or 200 to 230 or 210 to 230 or 215 to 225° C., and/or a temperature of the welding layer material is 230 to 260° C., preferably 230 to 255 or 230 to 250 or 235 to 245° C.

In another embodiment, the coextrusion coating step is performed in an extruder, which comprises a feed block with a feed block zone, and in which feed block zone a temperature of a tie layer material of a tie layer adjacent the welding layer and/or the welding layer material is 200 to 280° C., preferably 205 to 275 or 210 to 270 or 215 to 265 or 220 to 260 or 225 to 255 or 230 to 250 or 235 to 245° C.

One or more of the latter embodiments may make it possible to keep the temperature of the welding layer material low so as to achieve the advantages of this as described further above. In case two or more tie layers are included, the temperature of the tie layers may be substantially identical, or may be no more than 5 or 10° C. apart, in one or more or all zones of the extruder.

A tie layer material suitable for being coextrusion coated at the mentioned temperatures should be selected to fit the temperatures for the/each tie layer.

In case a second tie layer is present, the second tie layer being adjacent the base sheet layer, alternatively or additionally the following may apply:
a temperature of a tie layer material of the second tie layer is kept at or below a temperature of 260, 255, 250, 245 or 240° C. during all parts of the coextrusion coating step, and/or
in the feed zone a temperature of the tie layer material of the second tie layer is 120 to 160, preferably 125 to 155 or 130 to 150 or 135 to 145° C.; and/or
in the transition zone a temperature of the tie layer material of the second tie layer is 160 to 230, preferably 170 to 230 or 180 to 230 or 190 to 230 or 200 to 230 or 210 to 230 or 215 to 225° C.; and/or
in the metering/mixing zone a temperature of the tie layer material of the second tie layer is 230 to 280, preferably 230 to 270 or 230 to 260 or 230 to 250 or 235 to 245° C.; and/or
in the feed block zone a temperature of the tie layer material of the second tie layer is 220 to 260° C., preferably 225 to 255 or 230 to 250 or 235 to 245° C.

As was the case for the first tie layer, it is surprisingly possible to achieve satisfactory results with such low tie layer material temperatures even using a tie layer material comprising or consisting of EAA or EMAA, specifically an EAA or EMAA copolymer resin, as mentioned above. The recommended temperatures of such tie layer materials and alternatives are typically above such temperatures.

As mentioned previously, the inventors have found that, surprisingly, the temperature of the welding layer material may be kept surprisingly low during the coextrusion coating step. while achieving a satisfactory coextrusion coated sheet laminate. This especially alleviates the drawbacks mentioned above related to gas formation, degradation of material and burn in the welding layer.

Each of the tie layer material and the welding layer material melt in the extruder to become melts of the respective materials. The temperature of the material is generally defined herein as the temperature of the material when being fed, or, when it is melted, the melt. However, it may alternatively be measured at an inner surface of the apparatus enclosing a zone in which the melt flows or it may be the set temperature, which is set for a temperature zone in the extruder apparatus, see also further below.

Each of the tie layer material and the welding layer material may with the methods according to this disclosure generally be fed into the feed block through a respective separate feeder, which may comprise a worm or other means for transporting the materials through the feeder and into the feed block. As is common in extruders or coextruders, i.e. apparatuses for extruding sheet laminates comprising thermoplastic polymer materials, each feeder may comprise an initial feed zone, followed by a transition zone, followed by a metering/mixing zone, followed by an adapter and melt pipe zone, which leads into the feed block. Each zone may comprise one or more subzones, which may also be referred to as “zones” herein. In the feed zone the starting material fed into the feeder is softened and heated almost to the melting point. In the transition zone the material is melted to form a melt of the material, and pressure is built up. In the metering/mixing zone a uniform melt is created. In the adapter/melt pipe zone the material is transferred to the feed block. In a feed block upper zone and a feed block lower zone, structure is built up in the additional layer to be coextruded. The two melts are then coextruded from one single common die of the extruder. The feeder, the feed block, the adapter/melt pipe and/or the die may comprise one or more heaters or heating elements (and potentially coolers) that may be regulated by one or more regulators. The heaters may be set to heat the materials within the extruder to a given temperature in each of the zones. One or more of the heaters may be in the form of a mantle or casing that surrounds or encases a zone, e.g. as an outer tube. Heat energy may also be created due to friction within the extruder and especially within the feeder. When referring to a temperature within a zone in this context, reference is made to one or more of the set temperature, a mean temperature of the material or melt in the zone, a maximum temperature of the material or melt in the zone, a minimum temperature of the material or melt in the zone, a temperature measured at one point in or at the material or melt of the zone, a temperature of the heating element, and a temperature measured on or at an inside surface of the extruder in the respective zone. Usually, these temperatures will be close to each other although locally a temperature may divert with some ° C. The feed block may as mentioned comprise an upper and a lower zone, the upper zone being positioned subsequent to the adapter and melt pipe, and the lower zone leading into the die from which the coextruded melt is extruded. The die may comprise three interior zones in a transverse direction, each typically with two or three subzones in said transverse direction. The melts or extrudates within the die merge and weld together into a laminar structure to form the coextruded additional layer that is applied onto the base sheet layer before chilling or quenching. Chilling or quenching is carried out by applying the additional layer or the sheet laminate onto a cooling roller in a subsequently performed coating step of the coextrusion coating process. In the coating step the two or more coextruded melts are extruded onto the base sheet layer so that the coextruded additional layer adheres to the base sheet layer. The additional layer and the base sheet layer are guided through a nip between the cooling roller and an opposed pressure roller and pressure may be applied between the two rollers. The additional layer preferably faces the cooling roller, the base sheet layer preferably facing the pressure roller. As mentioned, a primer or the like may be applied to the base sheet layer before the coextruded melt is applied onto it. The base sheet layer is preferably extruded, and/or a potential primer is preferably applied, immediately before the additional layer is coextrusion coated onto it, i.e. less than 60, 30, 15, 5, 4, 3, 2 or 1 seconds before.

In the present embodiment, within the feed block the temperatures of the welding layer material and the tie layer material may be changed, preferably in the upper feed block zone, so as to be substantially identical; preferably the difference in temperature is less than 20, 15, 10, 9, 8, 7, 6, 5, 4, 3, 2 or 1° C. Additionally, the temperatures of the two materials may be kept identical, i.e. to have the same preferred temperature difference as the latter, from within the upper feed block zone and until the two materials exit from the die. The temperature may be substantially identical in all potential transverse zones or subzones of the die.

The temperature of the tie layer material may be lowered right before, at or after entry into the feed block, specifically the upper feed block, e.g. lowered with 1 to 30° C., 3 to 20° C., 5 to 15° C. or 8 to 12° C.

The temperature of the welding layer material may be equal to or 0 to 40 or 5 to 35 or 10 to 30 or 15 to 25° C. above the temperature of the tie layer material of an adjacent tie layer in the metering/mixing zone and/or at the entry into the feed block. The temperature of the welding layer material in the transition zone, the metering/mixing zone, the adapter/melt pipe zone and/or at the entry into the feed block may be 220 to 260, 225 to 255 or 230 to 250° C. or 235 to 245° C.

If the extruder comprises a feeder with a feed zone, a transition zone and a metering/mixing zone, the temperature of the two (or more) materials to be coextruded may be increased during such a sequence of zones. Experiments have shown that it is advantageous that the temperature of the welding layer material is raised to be relatively high in the feed zone, i.e. at least 160, 170, 175 or 180° C., and is then raised already in a first subzone of the transition zone to 220 to 260° C. or 230 to 250 or 235 to 245° C. The temperature of the welding layer material may then be kept substantially constant at this temperature through the transition zone and the metering/mixing zone as well as in the adapter/melt pipe zone. Experiments have shown that the starting temperature of the welding layer material is preferably higher than that of the tie layer material which, potentially, may be connected to the PS polymer material being relatively hard so that it should be heated more quickly to soften it so as to avoid destroying the welding layer material due to high friction within the feeder.

The tie layer may be heated through both the feed zone and the transition zone to assume a maximum temperature at or in the metering/mixing zone. The temperature of the tie layer may then be slightly lowered, e.g. with 5 to 15° C. or 8 to 12° C. on entry into or in the feed block, potentially the feed block upper zone.

Generally, in terms of this disclosure, the temperatures of the tie layer materials) and the welding layer material are preferably different from each other in a feed zone of the extruder.

The two (or more) materials to be coextruded may be transported through a feeder using a respective worm, screw or endless screw of the respective feeder. The respective materials may be fed separately to the respective feeder and/or separately to a common feed block and/or separately to a common die.

In the case where two tie layers are applied, during transport of the respective materials in the extruder, i.e. during the course of the coextrusion coating step, the temperature of the respective materials may have the following temperatures in ° C. in the above-mentioned different zones of an extruder (the references in parenthesis referring to the embodiment of FIG. 7, which is described further in the below detailed description of embodiments). The temperature interval in each zone may be combined with a temperature interval in one or more of the other zones, but the preferred combination of temperature intervals is given here:

| | | | Metering/ | Metering/ | Metering/ |
|---|---|---|---|---|---|
| | Feed | Transition | mixing | mixing | mixing |
| Zone | zone (1) | zone (2) | zone (3) | zone (4) | zone (5) |
| Tie layer 1 | 100-180 | 150-210 | 200-260 | 200-260 | 200-260 |
| (I) | | | | | |
| Tie layer 2 | 100-180 | 150-210 | 200-260 | 200-260 | 200-260 |
| (II) | | | | | |
| Welding | 160-220 | 210-270 | 220-275 | 220-275 | 220-275 |
| layer | | | | | |
| (III) | | | | | |

| | Feed block | Feed block | Die 1 | Die 2 | Die 3 |
|---|---|---|---|---|---|
| Zone | upper (F1) | lower, (F2) | (D1) | (D2) | (D3) |
| All layers | 220-275 | 220-275 | 220-275 | 220-275 | 220-275 |
| (I, II, III) | | | | | |

Alternative intervals are given here:

| | | | Metering/ | Metering/ | Metering/ |
|---|---|---|---|---|---|
| | Feed | Transition | mixing | mixing | mixing |
| Zone | zone (1) | zone (2) | zone (3) | zone (4) | zone (5) |
| Tie layer 1 | 115-180 | 160-230 | 230-270 | 230-280 | 230-280 |
| (I) | | | | | |
| Tie layer 2 | 115-160 | 160-190 | 190-220 | 215-240 | 215-240 |
| (II) | | | | | |
| Welding | 160-200 | 220-250 | 230-260 | 230-260 | 230-260 |
| layer | | | | | |
| (III) | | | | | |

| | Feed block | Feed block | Die 1 | Die 2 | Die 3 |
|---|---|---|---|---|---|
| Zone | upper (F1) | lower, (F2) | (D1) | (D2) | (D3) |
| All layers | 220-260 | 220-260 | 220-260 | 220-260 | 220-260 |
| (I, II, III) | | | | | |

The term “die” may alternatively be denoted “nozzle”.

Tie layer 1 is the tie layer adjacent the base sheet layer, whereas tie layer 2 is the tie layer adjacent the welding layer.

In embodiments where no tie layer 1 is present, i.e. the only tie layer present is the tie layer 2, the preferred temperatures are identical to the above for tie layer 2 and the welding layer.

The feed zone (1) may extend from about 0 to about ⅖ of an entire transport length from beginning to end of the feeder, the transition zone (2) may extend from about ⅕ to ⅗ of the length, a first subzone (3) of the metering/mixing zone from about ⅖ to ⅗ of the length, a second subzone (4) from about ⅗ to ⅘ of the length, and a third subzone (5) from about ⅘ to 5/5 of the length. From the first subzone (3) the temperature may be kept substantially constant until entry into the feed block. In the first subzone (F1) of the feed block, the temperature may of both materials be raised to 220 to 260° C., which may be the temperature at which the materials are kept through the lower subzone (F2) of the feed block and fed to the die and at which (D1/D2/D3) the materials are extruded from the die.

One or more of all of the above temperatures and temperature intervals may be combined.

Preferable approximate temperatures are:

| | | | Metering/ | Metering/ | Metering/ |
|---|---|---|---|---|---|
| | Feed | Transition | mixing | mixing | mixing |
| Zone | zone (1) | zone (2) | zone (3) | zone (4) | zone (5) |
| Tie layer 1 | 140-160 | 170-190 | 220-240 | 220-240 | 220-240 |
| (I) | | | | | |
| Tie-layer 2 | 140-160 | 170-190 | 220-240 | 220-240 | 220-240 |
| (II) | | | | | |
| Welding | 175-200 | 230-250 | 240-260 | 240-260 | 240-260 |
| layer | | | | | |
| (III) | | | | | |

| | Feed block | Feed block | Die 1 | Die 2 | Die 3 |
|---|---|---|---|---|---|
| Zone | upper (F1) | lower, (F2) | (D1) | (D2) | (D3) |
| All layers | 240-260 | 240-260 | 240-260 | 240-260 | 240-260 |
| (I, II, III) | | | | | |

Alternative approximate temperatures include:

| | Zone | | | | |
|---|---|---|---|---|---|
| | | | Metering/ | Metering/ | Metering/ |
| | Feed | Transition | mixing | mixing | mixing |
| | zone (1) | zone (2) | zone (3) | zone (4) | zone (5) |
| Tie layer 1 | 140 | 220 | 240 | 240 | 240 |
| (I) | | | | | |
| Tie layer 2 | 120 | 170 | 220 | 220 | 220 |
| (II) | | | | | |
| Welding | 180 | 240 | 240 | 240 | 240 |
| layer | | | | | |
| (III) | | | | | |

| | Zone | | | | |
|---|---|---|---|---|---|
| | Feed block | Feed block | Die 1 | Die 2 | Die 3 |
| | upper (F1) | lower, (F2) | (D1) | (D2) | (D3) |
| All layers | 240 | 240 | 240 | 240 | 240 |
| (I, II, III) | | | | | |

The method may further comprise a step of applying an antistatic layer of an antistatic agent to either of the two outer surfaces of the sheet laminate according to any embodiment of this disclosure. The step of applying the antistatic layer may be performed after, potentially as the next step after, the step of coextrusion coating. The antistatic layer may comprise 2-6 mg/m² antistatic agent, potentially 4 mg/m² antistatic agent. The antistatic layer may be applied by flexo printing and/or gravure printing. Flexo printing may also be known as flexography printing. Gravure printing may also be known as rotogravure printing. Alternatively or additionally, the antistatic layer is applied by immersion and/or by spraying.

The antistatic agent may form part of an antistatic mixture, wherein the method further comprises a step of mixing the antistatic agent with propan-2-ol and/or water, potentially being performed prior to the step of applying the antistatic agent, and wherein the step of applying the antistatic layer is performed by applying an antistatic layer of the antistatic mixture to an outer surface of the sheet laminate. Propan-2-ol may also be known as isopropanol or isopropyl alcohol. The antistatic mixture may contain 0.3%-1.0% antistatic agent by weight. The antistatic layer may comprise 0.5-2 g/m² antistatic mixture, potentially 1 g/m² antistatic mixture, so as to leave a antistatic layer of 2-6 mg/m² antistatic agent, potentially 4 mg/m² antistatic agent.

The antistatic agent may have a cationic ionic structure. The antistatic agent may be soluble in water, potentially distilled water. The antistatic agent may reduce the electrostatic charge of polymer surfaces potentially by reducing the surface resistance to potentially 10⁷-10⁸ ohm, potentially measured according to DIN IEC 60 093/DIN EC 60 167. The antistatic agent may be NEOSTATIC® HB 155 as per May 2018.

It has been observed that a stack of sheet laminates comprising an antistatic layer as mentioned above is easier to separate than without the antistatic layer.

The present disclosure also comprises a method for manufacture of a punched sheet lid, comprising the steps of:
manufacturing a sheet laminate in accordance with the methods according to this disclosure for making a sheet laminate, and
punching a sheet lid from the sheet laminate.

The punched sheet lid is preferably pre-punched, i.e. punched or cut before attachment to a container. The method may further comprise the step of attaching the punched sheet lid to a container in advance of or after pre-punching the punched sheet lid. The step of attaching the sheet lid may include arranging the sheet lid such that the welding layer is facing an attachment surface of the container, said attachment surface potentially comprising PS. Optionally, the step of applying the antistatic layer is performed before the step of punching, potentially by lacquering the sheet laminate with the antistatic layer.

The present disclosure also comprises a method for manufacture of a package, comprising the steps of:
manufacturing a punched sheet lid in accordance with the methods according to this disclosure for manufacture of a sheet lid,
providing a container manufactured from PS or comprising an outer welding layer comprising PS,
subsequent to punching the sheet lid, arranging the sheet lid with a bottom surface of the welding layer facing a welding surface of the container, said welding surface surrounding an opening of the container, and
welding the bottom surface of the welding layer of the punched sheet lid to the welding surface of the container.

Thus, according to this embodiment the sheet lid is pre-punched. The sheet lid may be welded to the container to close and/or seal the container. The container may subsequently be opened by pulling by hand in a periphery, potentially a tab, of the lid, whereby the lid may delaminate substantially in a welding area only.

The container and/or package may contain a foodstuff product, specifically a dairy product, which may be closed into the container before the step of arranging the sheet lid to face the welding surface of the container. Hereby, the manufactured package will comprise a sealed foodstuff product.

The container or the welding layer on the container may comprise at least 50, 60, 70, 80, 90, 95% or substantially 100% PS or EPS, and/or the material thereof may be identical to that of the welding layer of the sheet lid.

The present disclosure also comprises a sheet laminate obtainable by the methods according to this disclosure for making a sheet laminate.

The present disclosure also comprises a punched sheet lid obtainable by the methods according to this disclosure for making a punched sheet lid.

The present disclosure also comprises a package obtainable by the methods according to this disclosure for making a package.

The present disclosure also comprises a sheet laminate for being pre-punched to a sheet lid for a container, comprising:
a base sheet layer, and
an additional sheet layer, which comprises a tie layer comprising polyolefin and a welding layer comprising polystyrene (PS), the tie layer being disposed between the base sheet layer and the welding layer.

The sheet laminate may be manufactured according to any of the above embodiments of the methods according to this disclosure for manufacture of a sheet laminate. Thus, the base sheet layer may comprise or substantially consist of polyester, specifically PET or OPET.

Any and all of the above examples of thicknesses, contents etc. of the different layers and their properties and described above in relation to the methods according to this disclosure for manufacture of a sheet laminate may also individually or combined apply to the sheet laminates according to this disclosure.

In an embodiment of the present sheet laminate the additional sheet layer has been coextrusion coated onto said base sheet layer. It can be determined from a sheet laminate comprising such a base sheet layer and such an additional sheet layer that the additional sheet layer has been coextrusion coated onto the base sheet layer since the additional sheet layer will in that case adhere to the base sheet layer without a separate adhesive layer being provided between the two layers. Accordingly, this embodiment may alternatively or additionally be defined as there not being a separate adhesive layer or glue layer that includes a hardener or a hardening agent/component, present between the additional sheet layer and the base sheet layer. An adhesive or glue layer that includes a hardener or a hardening agent/component may be defined as a layer that comprises or essentially consists of a two-component adhesive or a two-component glue such as a polyurethane (PU) based adhesive/glue, available from, for example, Henkel AG, Coim Spa or Dow Chemical. Alternatively, it can be immediately determined from a sheet laminate that the additional sheet layer has been coextrusion coated onto the base sheet layer since in that case the sheet laminate will have very small curl compared to if it were manufactured in any other manner, see further below regarding curl.

In another embodiment of the sheet laminate, the magnitude of curl K of the sheet laminate measured according to ISO 11556:2005(E), second edition 2005, is equal to or less than 10 m⁻¹, and/or the chord-to-arc distance h of the sheet laminate measured according to ISO 11556:2005(E), second edition 2005, is equal to or less than 20 mm.

The value K is preferably equal to or less than 9, 8, 7, 6, 5, 4, 3, 2, 1, 0.5, 0.1, 0.05, 0.01, 0.005 or 0.002 m⁻¹. Alternatively, or additionally, the value h of the sheet laminate is preferably equal to or less than 50, 30, 15, 12, 10, 9, 8, 7, 6, 5, 4, 3, 2, 1 or 0.5 mm.

The determination of the values K and/or h is generally done using the standard ISO 11556:2005(E), second edition 2005 (which is hereby incorporated by reference), in the following way:

FIG. 9 shows a side view of a circular test piece T with an area size of 100 cm² (corresponding to a diameter of 112.8 mm), The test piece T is cut or punched from the sheet laminate. The test piece T is substantially undamaged and without conditioning. Sampling is done using ISO 186:2002. The test piece T is supported, e.g. using an apparatus according to Annex B of the said ISO standard, and the test piece T is allowed to curl until substantially reaching an end state in which it substantially no longer curls, typically no more than at the most 1 second or so is necessary. The curl is measured with the test piece T suspended such that the axis of the curl is vertical. The measurement is made at atmospheric humidity of 50% and temperature of 20° C. The exposure and measurement procedures according to the ISO standard's section 8.2 are carried out. Chord length C (measured in mm) and chord-to-arc distance h (measured in mm), see FIG. 9, are measured using, e.g., the tool of Annex C of ISO 11556:2005(E), second edition 2005. Chord length C in mm is measured across the centre of the test piece T. The chord-to-arc distance h is the maximum distance from the chord to the arc, in mm, measured upon a line perpendicular to the chord. The magnitude of curl K in m⁻¹ is calculated according to section 9 of the ISO standard as:

$$K = \frac{8 h}{{C}^{2} + 4 {h}^{2}} * 1000$$

The present also comprises a laminated sheet lid for a container comprising:
a base sheet layer, and
an additional sheet layer, which comprises a tie layer comprising polyolefin and a welding layer comprising polystyrene (PS), the tie layer being disposed between the base sheet layer and the welding layer.

The present laminated sheet lid may be punched from the sheet laminates according to this disclosure.

The sheet lids according to this disclosure may be manufactured according to any of the above embodiments of methods for making a sheet laminate, the lid being punched or cut from the manufactured sheet laminate.

Any and all of the above examples of thicknesses, contents, temperature intervals etc. of the different layers and materials and their properties as described above in relation to the methods for manufacture of a sheet laminate may also individually or combined apply to the sheet lids according to this disclosure.

The additional sheet layer of the sheet lid has preferably been coextrusion coated onto said base sheet layer. It can be determined from a sheet lid comprising such a base sheet layer and such an additional sheet layer that the additional sheet layer has been coextrusion coated onto the base sheet layer since the additional sheet layer will in that case adhere to the base sheet layer without a separate adhesive or glue layer including a hardener or hardening component (see also above) being provided between the two layers. Accordingly, this may alternatively be defined as there not being an adhesive layer present between the additional sheet layer and the base sheet layer.

Also, it can be immediately determined from a sheet lid that the additional sheet layer has been coextrusion coated onto the base sheet layer since in that case the sheet lid will have very small curl compared to if it were manufactured in any other manner.

Thus, the curl of the sheet lid may, comparably to the above sheet laminate be low, defined as the K value of the sheet lid measured according to ISO 11556:2005(E), second edition 2005, being equal to or above 100 m⁻¹, and/or the h value of the sheet lid measured according to ISO 11556:2005(E), second edition 2005, being equal to or above 100 mm.

The value K of the sheet lid is preferably equal to or less than 9, 8, 7, 6, 5, 4, 3, 2, 1 or 0.5 m⁻¹. Alternatively, or additionally, the value h of the sheet laminate is preferably equal to or less than 15, 12, 10, 9, 8, 7, 6, 5, 4, 3, 2, 1 or 0.5 mm.

The sheet lids according to this disclosure may be a pre-punched sheet lid, i.e. be in a condition after having been punched, but before having been attached to a container.

The present disclosure also comprises a package comprising a container with a sheet lid, wherein
the sheet lid is according to any one of the above embodiments of a sheet lid,
the container is a PS container or comprises an outer welding layer comprising PS,
the sheet lid is arranged with the welding layer facing a welding surface of the container, said welding surface surrounding an opening of the container, and
a bottom welding surface of the welding layer of the punched sheet lid is welded to the welding surface of the container.

The sheet lid may be welded to the container to close and/or seal the container. The container may subsequently be opened by pulling in a periphery, potentially a tab, of the lid, whereby the lid may delaminate substantially in a welding area only. The container and/or package may contain a foodstuff product, specifically a dairy product, which may be closed into the container before the step of arranging the sheet lid to face the welding surface of the container. Hereby, the manufactured package will comprise a sealed foodstuff product.

The container or the welding layer on the container may comprise at least 50, 60, 70, 80, 90, 95% or substantially 100% PS or EPS, and the material thereof may be identical to that of the welding layer of the sheet lid.

### BRIEF DESCRIPTION OF THE DRAWINGS

Embodiments will be described in the following detailed description with reference to the drawings in which:

FIG. 1 shows a perspective view of an embodiment of a package manufactured according to an embodiment of a method for making a package, the package comprising a container and an embodiment of a sheet lid manufactured from an embodiment of a sheet laminate, the package being shown prior to welding the lid to the container,

FIG. 2 shows a detail of the package of FIG. 1 in a sectional view taken along the line II-II in FIG. 1 after the sheet lid has been torn off of the container, i.e. after delamination,

FIG. 3 shows a schematic sectional view of a sheet laminate from which the sheet lid of FIG. 1 has been cut,

FIG. 4 shows a schematic sectional view corresponding to that of FIG. 3 of an alternative embodiment of the sheet laminate,

FIG. 5 shows a schematic sectional view corresponding to that of FIG. 3 of another alternative embodiment of the sheet laminate,

FIG. 6 is a schematic view of an extruder for coextrusion of an additional layer of the sheet laminate according to any one of FIGS. 3 to 4,

FIG. 7 is a flow diagram illustrating a coextrusion process carried out in the extruder of FIG. 6, showing temperature zones in the different parts of the extruder,

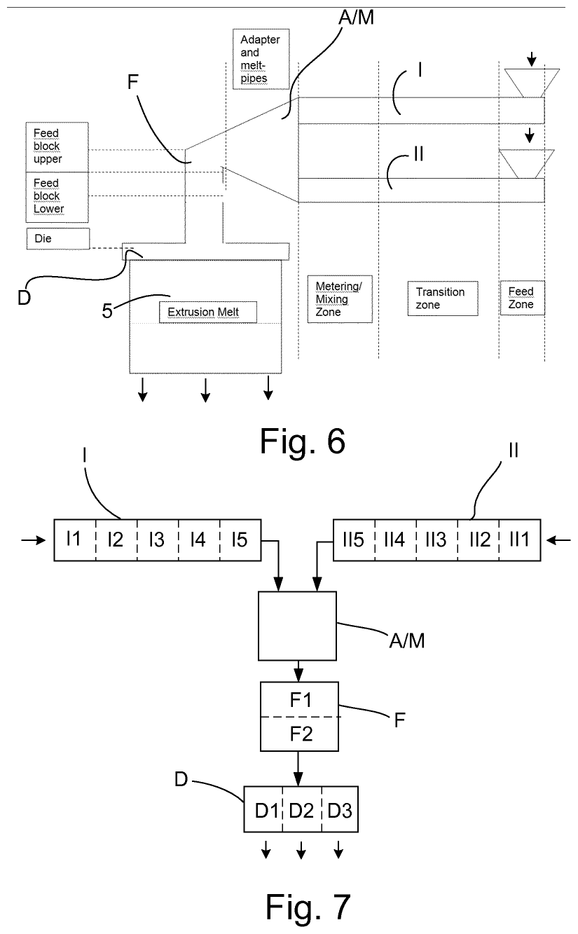

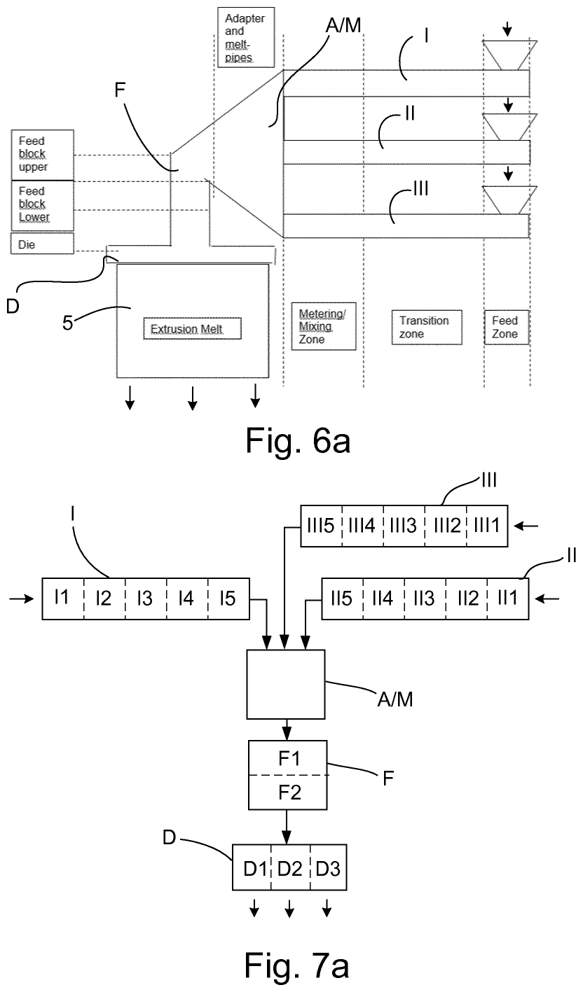

FIG. 6a is a view similar to that of FIG. 6, showing an extruder for coextrusion of an additional layer of the sheet laminate according to any one of FIG. 5,

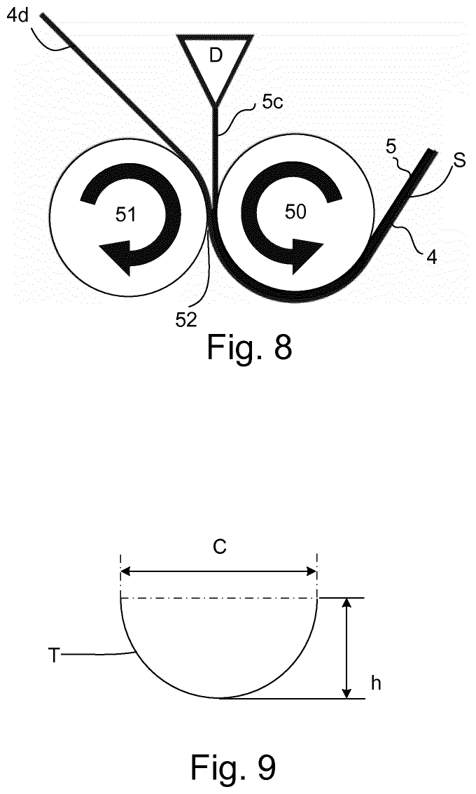

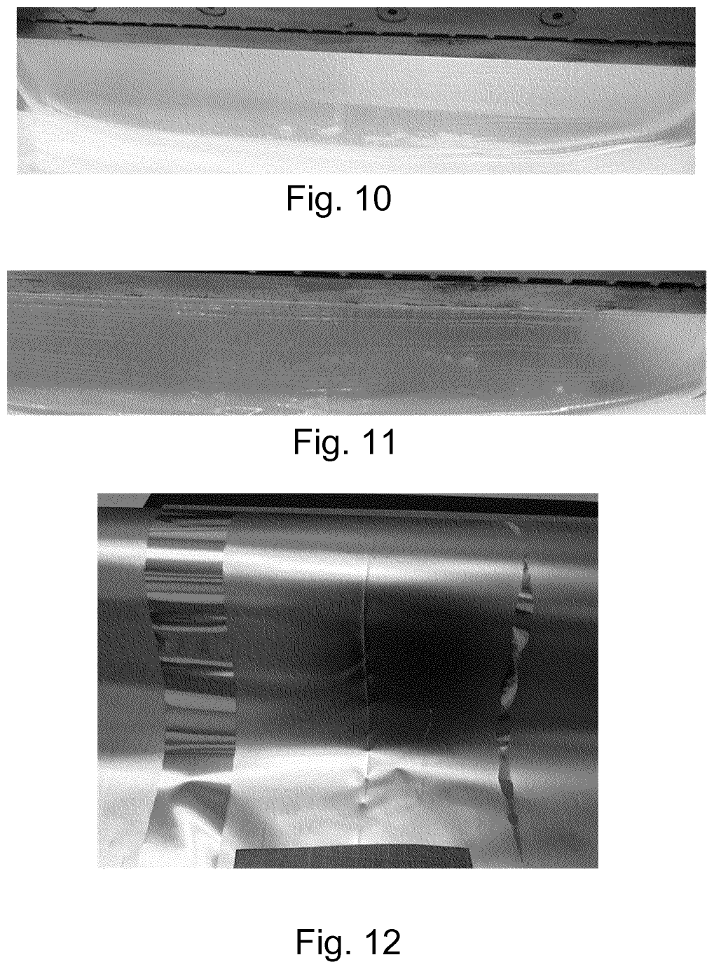

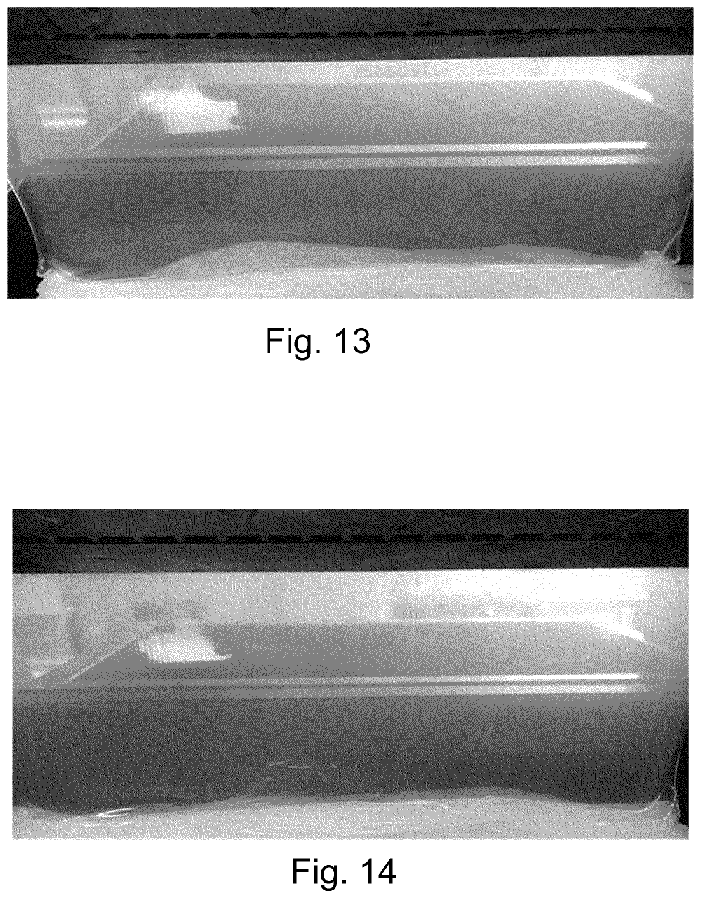

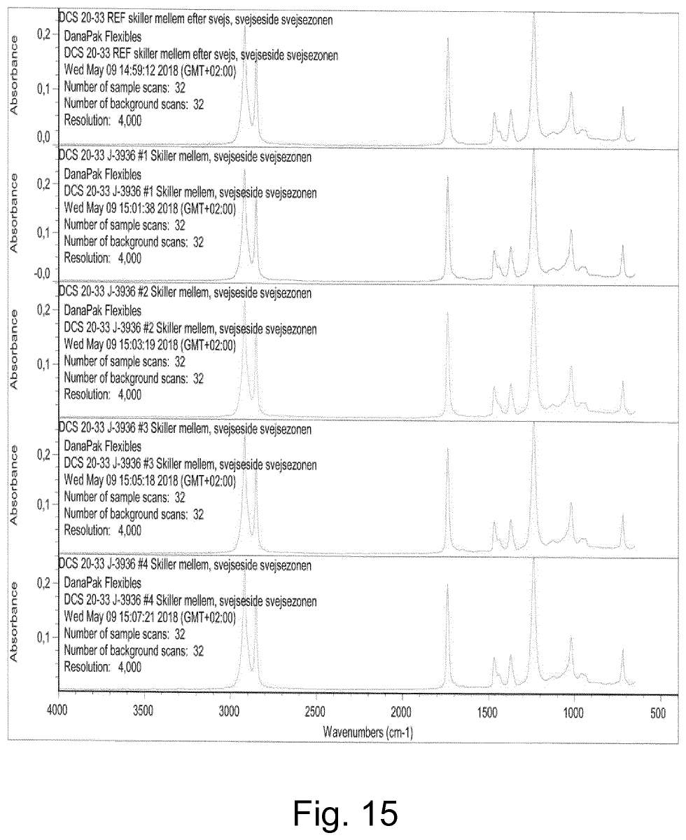

FIG. 7a is a flow diagram similar to that of FIG. 7 and illustrating a coextrusion process carried out in the extruder of FIG. 6a, showing temperature zones in the different parts of the extruder,

FIG. 8 shows a schematic side view of an apparatus for a coating process following the coextrusion process of FIG. 7 for coating the coextruded additional layer onto a base sheet layer, and

FIG. 9 shows a schematic side view of a test sample of a sheet laminate for measuring curl,

FIG. 10 shows a photographic representation of a melt curtain during manufacture of a first sample sheet laminate,

FIG. 11 shows a photographic representation of a melt curtain during manufacture of a second sample sheet laminate,

FIG. 12 shows a photographic representation of a coating distribution on the second sample sheet laminate,

FIG. 13 shows a photographic representation of a melt curtain during manufacture of a third sample sheet laminate,

FIG. 14 shows a photographic representation of a melt curtain during manufacture of a fourth sample sheet laminate, and

FIG. 15 shows IR scans of the sealing zone after separation of a sample sheet laminate and a thick PS-film.

### DETAILED DESCRIPTION

In this specification, generally, when terms such as “thickness” (measured in μm) and “distribution” (measured in g/m²) are used, unless otherwise indicated it is to be understood that the layer in question has a substantially or essentially uniform thickness across the planar extent of the layer or sheet or laminate according to the stated value.

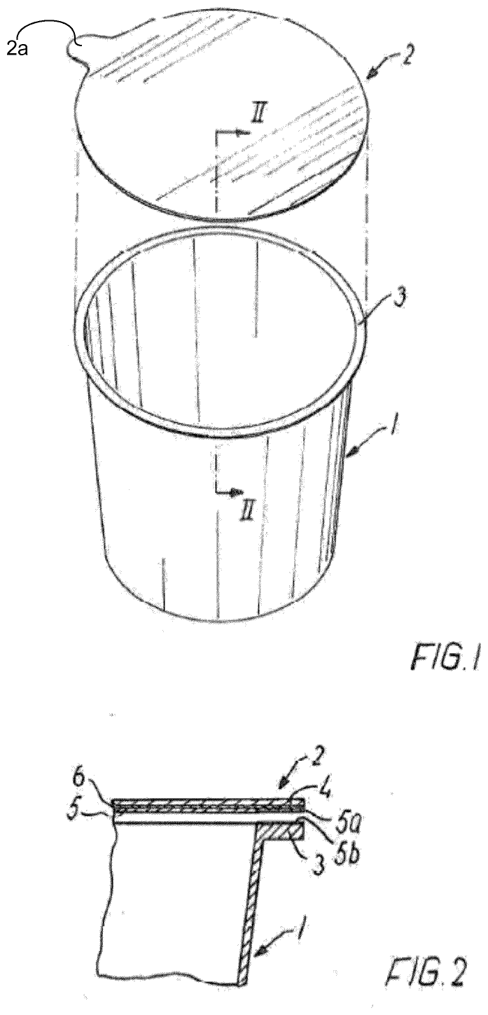

The package shown in FIGS. 1 and 2 is an embodiment of the packages according to this disclosure and is manufactured according to an embodiment of the methods according to this disclosure for making a package.

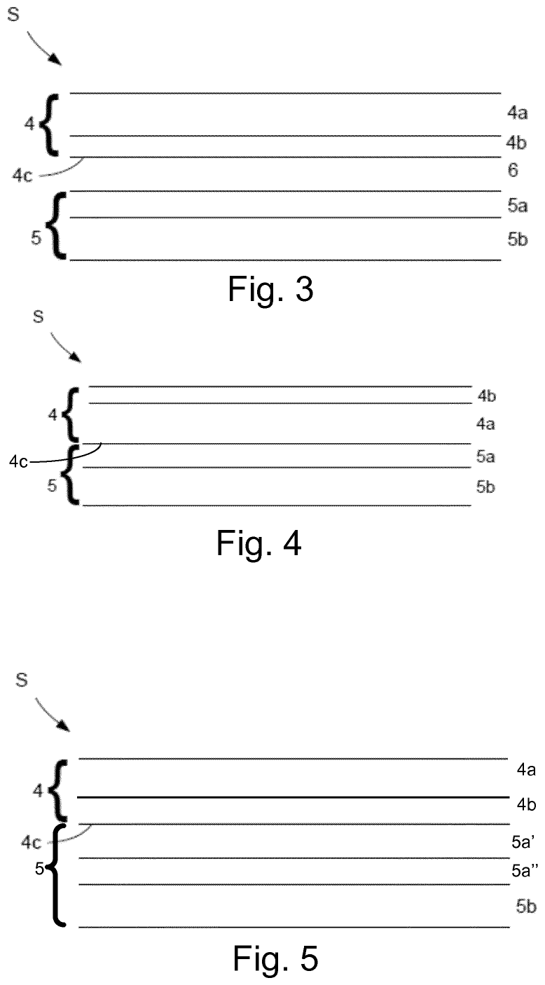

The package comprises a container 1 and an embodiment of the sheet lids according to this disclosure, denoted 2, which sheet lid 2 is manufactured from the embodiment of a sheet laminate, which sheet laminate is denoted S and is illustrated in FIG. 3.

In FIG. 1 the package is shown before welding the lid 2 to the container 1.

FIG. 2 shows a detail of the package of FIG. 1 in a sectional view taken along the line II-II in FIG. 1 after the sheet lid 2 has been torn off of the container 1, i.e. after delamination.

The container 1 is manufactured of thermoformed polystyrene (PS).

The container 1 is provided with an upper welding rim 3, which is plane on an upper surface facing the sheet lid 2 to enable welding of the sheet lid 2 onto the upper surface of the rim 3 to produce the closed and sealed package. The rim 3 is a flange projecting in an outwards direction along an opening of the container 1.

When the container 1 has been filled with its contents, which may be foodstuff, such as a dairy product, it is closed with the sheet lid 2. The sheet lid 2 has been pre-punched, i.e. punched in advance of closing the container, from the sheet laminate S shown in FIG. 3 and is thus adapted in shape and size to the opening of the container 1, specifically the rim 3, before welding.

Referring to FIG. 3, the sheet laminate S and thus the punched sheet lid 2 comprise a base sheet layer 4, the base sheet layer 4 in the shown embodiment comprising a polyester top layer 4a, which has a thickness of about 36 μm. This thickness is adapted to the need for strength, barrier properties, and other functional requirements of the container 1. The polyester layer 4a consists of polyester, specifically OPET. The base sheet layer 4 also comprises a barrier coating 4b, specifically a SiOx coating coated onto a first major surface of the OPET layer 4a and having a thickness of less than 1 μm, whereby an oxygen transmission rate of the sheet laminate of less than 3 cm³/m²/24 h/bar and a water vapour transmission rate of less than 3 g/m²/24 h is achieved.

The base sheet layer 4 can in an alternative embodiment additionally be metallized on its second major surface, the metal layer being provided with an outer protective lacquer to prevent the metal layer from being scratched or damaged.

An additional sheet layer 5 comprising a tie layer 5a, essentially consisting of an EVA copolymer resin, specifically Escorene™ Ultra UL 00728EL, and a PS welding layer, specifically a HIPS layer 5b, has been coextrusion coated onto the base sheet layer 4. Thus, the additional sheet layer 5 is provided by coextrusion coating of the two layers 5a and 5b onto a first major surface 4c of the base sheet layer 4. The welding layer 5b is intended to be welded to the upper surface of the rim portion 3 of the container 1.

All of the base sheet layer 4, the tie layer 5a, the welding layer 5b, the sheet laminate S and the sheet lid 2 are transparent, but somewhat milky due to the somewhat milky HIPS used in the welding layer, and allow substantially 50% of visible light to pass through them.

An extruder used in the coextrusion process of the coextrusion coating step of the method for making of the sheet laminate S is shown in FIG. 6. The coextrusion process of the coextrusion coating step is schematically illustrated in the diagram of FIG. 7. The coating process of the coextrusion coating step is illustrated in FIG. 8, which schematically shows the coating process carried out on an apparatus for the coating step.

Referring to FIG. 6, the extruder or coextruder shown is a conventional apparatus for coextruding sheet laminates comprising thermoplastic polymer materials. It comprises two respective feeders I and II, where a PE tie layer granulate is fed into feeder I, and a PS welding layer granulate is fed into feeder II at the arrows in the figure. Each feeder I, II comprise a worm for transporting the respective material through the feeder I, II and into a feed block F via an adapter/melt pipe A/M.

Referring now also to FIG. 7, each feeder I, II comprise an initial feed zone I1, II1, respectively, followed by a transition zone I2; II2 (which may in other embodiments comprise two or more subzones), followed by a metering/mixing zone with subzones I3, II3; I4, II4; I5, II5, respectively. The metering/mixing zone is followed by an adapter/melt pipe A/M zone, which leads into the feed block F. In the respective feed zone I1, II1 the respective material fed into the respective feeder I, II is softened and heated almost to the melting point. In the transition zone I2, II2 the material is melted and pressure is built up. In the metering/mixing subzones I3, II3; I4, II4; I5, II5 a respective uniform melt of the respective material is created. In the A/M zone the two melts are transferred to meet in the feed block F. In a feed block upper zone F1 and a feed block lower zone F2, structure is built up in the two melts to be coextruded. The two melts are then coextruded from a die D with a nozzle width of 1550 mm to form the additional layer 5, see FIG. 6. Generally, the nozzle width of the Die D usually may vary from 1000 mm to 2500 mm. The feeders I, II, the adapter/melt pipe A/M, the feed block F and/or the die D comprise a number of not shown conventional heaters that are temperature regulated by a not shown conventional regulator or controller. The regulator sets the heaters to heat the materials within the extruder to a given temperature in each of the zones. Temperature measurements in one or more of the temperature zones are provided to the regulator to allow the regulator to regulate the zone temperatures according to the set temperatures. The heaters take the form of one or more mantles or casings that surround or encase part or all of each of the apparatus parts I, II, A/M, F and D, Heat energy is also created due to friction inside the extruder, especially within the feeders I, II. When referring to a temperature within a zone in the following, reference is made to the set temperature of the heater in that zone.

As mentioned, the feed block F comprises an upper zone F1 and a lower zone F2, the upper zone F1 being positioned subsequent to the adapter and melt pipe NM zone, and the lower zone F2 leading into the die D from which the coextruded melt is extruded. The die D comprises three interior zones D1, D2, D3 in a transverse direction, each interior zone having three subzones (not shown). The melts or extrudates of the materials merge and weld together into a laminar structure within and/or when exiting the die D to form the coextruded additional layer 5 that is applied onto the base sheet layer 4 before chilling as described below.

The feed zones I1, II1 extend from about 0 to about ⅕ of an entire transport length from beginning to end of the respective feeder I, II, the transition zone I2, II2 extends from about ⅕ to ⅖ of the length, the respective subzone I3, II3 of the metering/mixing zone from about ⅖ to ⅗ of the length, the second subzone I4, II4 from about ⅗ to ⅘ of the length, and the third subzone I5, II5 from about ⅘ to 5/5 of the length.

The set temperatures of the heaters of the extruder are shown below in ° C. for each zone/subzone:

| | Zone | | | | |
|---|---|---|---|---|---|
| | | | Metering/ | Metering/ | Metering/ |
| | Feed | Transition | mixing | mixing | mixing |
| | zone 1 | zone 2 | zone 3 | zone 4 | zone 5 |
| Tie layer | 120 | 170 | 220 | 220 | 220 |
| (I) | | | | | |
| Welding | 180 | 240 | 240 | 240 | 240 |
| layer | | | | | |
| (II) | | | | | |

| | Zone | | | | |
|---|---|---|---|---|---|
| | Feed block | Feed block | Die 1 | Die 2 | Die 3 |
| | upper F1 | lower F2 | D1 | D2 | D3 |
| Both | 240 | 240 | 240 | 240 | 240 |
| layers | | | | | |
| (I, II) | | | | | |

Now referring also to FIG. 8, in the coating process of the coextrusion coating step the base sheet layer 4 is continuously rolled off from a feed roll to be moved between two rollers, specifically a cooling roller 50 and a counter roller or pressure roller 51. The cooling roller has a chilled or cooled outer surface onto which a melt 5c of the material eventually forming the additional layer 5 is applied from the extruder die D of FIGS. 6 and 7 (which is seen from a lateral side in FIG. 8 as opposed to FIG. 6 where it is seen in a plane view) so as to be positioned between a base sheet 4d, which eventually forms the base sheet layer 4, and the cooling roller 50. The coextrusion coating step shown in FIGS. 6 to 8 is thus a continuous process, the rollers 50, 51 rotating along the arrows in FIG. 8 to continuously pull the base sheet 4d off the not shown feed roll. Upon contact with the base sheet 4d at or right before a nip 52 between the rollers 50, 51, the melt 5c adheres to the base sheet 4d. Subsequently or at the same time, upon contact with the cooling roller 50, the melt 5c is chilled to solidify.

The result is the laminate sheet S comprising the base sheet layer 4 coated with the additional layer 5, which is then rolled up on a not shown collecting roller. The additional layer melt 5c comprises the two melts of the materials of the layers 5a and 5b that are coextruded, i.e. extruded together through the single die D of the extruder shown in FIG. 6. Thus, the two coextruded melts of the additional layer melt 5c are coextruded onto the base sheet 4d so that the coextruded additional layer 5 adheres to the base sheet layer 4 so as to form the sheet laminate S shown in FIG. 3. The additional layer melt 5c and the base sheet layer 4 are guided through the nip 52 between the cooling roller 50 and the opposed pressure roller 51 so that the additional layer melt 5c faces and contacts the cooling roller 50 and the base sheet 4d faces and contacts the pressure roller 51.

The tie layer 5a essentially consists of a copolymer of PE, specifically an acrylate-containing copolymer of PE or an ethyl vinyl acetate (EVA) containing PE. Use of any one of these copolymers or a combination of these may ensure that delamination between the welding layer 5b and the polyethylene layer 5a only occurs in the welding area, i.e. at the upper surface of the rim 3 and may ensure sufficient welding strength.

The two layers 5a and 5b are distributed in an accumulated amount of 15 g/m². The tie layer 5a is distributed in an amount of about 10 g/m² or has a thickness of about 11 μm. The welding layer 5b is distributed in an amount of about 5 g/m² or has a thickness of about 5 μm.

The base sheet layer 4 may alternatively be extruded immediately before the additional layer 5 is coextrusion coated onto it.

Referring also to FIG. 3, an extrusion primer is applied to the base sheet 4 to form a primer layer 6 before the coextruded melt 5c is applied onto the base sheet 4 to form the sheet laminate S. The primer layer 6 provides enhanced adhesion between the first major surface 4c of the base sheet layer 4 and the polyethylene tie layer 5a. This primer layer can be avoided if a less strong adherence is desired.

The primer layer 6 is applied to the base sheet 4d immediately before, i.e. 0 to 20, 1 to 10, 2 to 7 seconds before, the step of coextrusion coating. The primer layer 6 essentially consists of a polyethyleneimin based primer.

The resultant sheet laminate S shown in FIG. 3 is weldable in its full planar extent. Thereby, any lid shape and dimension may be punched from a roll of the sheet laminate S the resultant sheet lid 2 being adapted to the size and shape of the container 1 and being weldable thereto without the need for applying a welding lacquer. The lid sheet S is supplied from the collecting roll of the sheet laminate S and is punched into its final shape of the sheet lid 2 prior to being applied to the container 1.

The container or cup 1 is filled with foodstuff in a filling machine, and the sheet lid 2, pre-punched to its final shape, is applied to the container 1 subsequently and welded to the rim portion 3 to seal the container 1.

When the container 1 has thus been filled with the foodstuff and closed with the sheet lid 2, a user may pull off the lid 2 by pulling in a periphery of the sheet lid 2, specifically in a peripheral lid flap or lid tap 2a visible in FIG. 1. Hereby, the tie layer 5a and the welding layer 5b will be separated or delaminated from each other in such a manner that the pulling-off or opening of the package along the rim portion 3 is controlled and precise, the welding layer 5b essentially remaining on the container 1 in the welding area, i.e. on the rim portion 3 thereof, and remain on the lid 2 in the non-welded area, see FIG. 2.

Optionally, an additional print or colour layer may be applied in a generally known manner on for example a top surface or a bottom surface of the sheet lid 2 either before or after the punching of the lid 2, and/or an additional barrier coating may optionally be applied to the sheet laminate before or after the punching.

The punched sheet lid 2 essentially does not curl after the punching, specifically even when it is not attached to the container 2, see also the examples below.

In an alternative embodiment of FIG. 3, the barrier coating 4b instead is positioned to face away from the tie layer 5a.

FIGS. 4 and 5 show views similar to that of FIG. 3, but of two respective alternative embodiments of the sheet laminate. These sheet laminates S are generally identical to the embodiment of the sheet laminate S shown in FIGS. 1 to 3 and made by an identical method, except for the differences mentioned in the following for each of the alternative embodiments.

In the embodiment of FIG. 4, the barrier coating 4b is applied to the second or outer major surface of the polyester layer 4a so that the tie layer 5a is in direct contact with the first major surface 4c of the polyester layer 4a of the base sheet layer 4, The tie layer 5a is made from an acrylate containing PE polymer with sufficient adherence to both PET and PS so that the additional sheet layer 5 can be coextrusion coated directly onto the base sheet layer 4 without the use of a primer layer 6.

In an alternative embodiment of FIG. 4, the barrier coating 4b instead is positioned to face the tie layer 5a.

FIG. 5 shows another embodiment of the sheet laminate, which is similar to and made by an identical method as that of FIGS. 3 and 4 except for the following differences.

In FIG. 5, a metallization 4b of the base sheet layer, i.e. a metal layer 4b including Al, faces the tie layer, in this case an upper tie layer 5a′. No primer layer 6 as in FIG. 3 is present in the embodiment of FIG. 5. The additional sheet layer 5 includes two tie layers 5a′ and 5a″, these two tie layers corresponding to the tie layers 1 and 2, respectively, as described in the general description above. The two tie layers 5a′, 5a″ comprise respective polymers which have sufficiently high adherence to their respective adjacent layers for the sheet laminate S to not unintentionally delaminate, i.e. the sublayer 5a′ adjacent to the base sheet layer 4 adheres to the PET of the base sheet layer 4 and the adjacent tie layer 5a″, the latter in turn adhering to the welding layer 5b.

FIGS. 6a and 7a show views similar to those of FIGS. 6 and 7, respectively, but including not only two feeders I and II, but three I, II and III. The feeder I feeds the tie layer 5a′ material, feeder II feeds the tie layer 5a″ material, and feeder Ill feeds the welding layer 5b material. The process of manufacture is otherwise similar to as described in connection with FIGS. 6 and 7.

Referring to FIGS. 6a and 7a, the temperatures applied in the process of manufacture of the Sheet S of FIG. 5 are the following:

| | Zone | | | | |
|---|---|---|---|---|---|
| | | | Metering/ | Metering/ | Metering/ |
| | Feed | Transition | mixing | mixing | mixing |
| | zone (1) | zone (2) | zone (3) | zone (4) | zone (5) |
| Tie layer | 140 | 220 | 240 | 240 | 240 |
| 1, 5a′ (I) | | | | | |
| Tie layer | 120 | 170 | 220 | 220 | 220 |
| 2, 5a″ (II) | | | | | |
| Welding | 180 | 240 | 240 | 240 | 240 |
| layer 5b | | | | | |
| (III) | | | | | |

| | Zone | | | | |
|---|---|---|---|---|---|
| | Feed block | Feed block | Die 1 | Die 2 | Die 3 |
| | upper (F1) | lower, (F2) | (D1) | (D2) | (D3) |
| All layers | 240 | 240 | 240 | 240 | 240 |
| (I, II, III) | | | | | |

The thickness of the welding layer 5b is about 3 μm. The thickness of the tie layer 5a′ is about 3 μm. The thickness of the tie layer 5a″ is 6 μm. No primer layer is present. The thickness of the polyester base sheet layer is about 36 μm.

The tie layer 5a′ essentially consists of Escor™ 5110, and the tie layer 5a″ essentially consists of Escorene™ Ultra UL 00728EL, mentioned above. The welding layer 5b essentially consists of HIPS.

In an alternative embodiment of FIG. 5, the metal layer 4b is not present or is present on the opposite surface of the base sheet layer 4a.

The sheet laminate S shown in FIGS. 4 and 5 may be applied to the container 1 as shown in FIGS. 1 and 2 in a similar manner as described above.

Generally, in the sheet laminates S and the sheet lids 2 described above the layers are preferably provided extending substantially along the entire area of the adjacent layer so that the area sizes of major surfaces of all layers are similar to each other.

### Example 1

A sample of the sheet laminate S according to FIG. 5 was manufactured in a coextrusion coating process as described above with reference to FIGS. 6a and 7a.

No significant bubbles (due to production of gases), material degradation or burns were detected in the welding layer 5b of the sample.

A test sample was punched from the sheet laminate sample, and the value h of the test sample was measured according to ISO 11556:2005(E), second edition 2005, in the manner described in the above with reference to FIG. 9. The value h for the test sample was measured to less than 3 mm, and the value C was measured to 112.7 mm, the K value accordingly being calculated to be less than 0.002 m⁻¹. The test sample of the sheet laminate thus had no or only very small curl.

A lid sample was pre-punched from the sheet laminate sample to correspond in size to an opening or rim of a thermoformed PS cup similar to the container 1 shown in FIG. 1 with an opening diameter of about 100 mm. The lid sample had no detectible curl and welded well to the respective container, the welding strength being above 5 N per 15 mm. The welding between lid sample and container resisted 0.3 atmosphere overpressure in the container for over 30 seconds.

The container was subsequently opened by pulling in a peripheral lid flap of the lid sample. The welding layer 5b of the lid sample essentially remained on the container in the welding area, i.e. on a rim portion of the container, and remained on the lid sample in the non-welded area, similar to as shown in FIG. 2.

### Example 2

An initial explorative screening of different sheet laminate material combinations was carried out.

The sheet laminates according to the embodiments above were manufactured according to embodiments of the present disclosure with the following layers in succession:
a base sheet layer of metallized PET (MET-PET) with a layer thickness of 36 μm, and
an additional sheet layer, which comprised two tie layers and a welding layer, the two tie layers being disposed between the base sheet layer and the welding layer, the first tie layer being adjacent to the base sheet layer, the second tie layer being adjacent to the welding layer, the additional sheet layer being coextrusion coated onto the base sheet layer.

The following two sheet laminate material combinations were selected for further tests. The respective layers essentially consisted of the material provided in the tables below for each respective sheet laminate.

Sheet laminate #1

| | | |
|---|---|---|
| Layer | Material | Layer thickness/distribution |

| | | | |
|---|---|---|---|
| Base sheet layer | Metallized PET | 36 | μm |
| First tie layer | Nucrel ® 0609 HSA | 3 | g/m² |
| Second tie layer | Lotader ® 4503 | 6 | g/m² |
| Welding layer | HIPS 3630 | 3 | g/m² |

Sheet laminate #2

| Layer | Material | Layer thickness/distribution | |
|---|---|---|---|
| Base sheet layer | Metallized PET | 36 | μm |
| First tie layer | Escor ™ 5110 | 3 | g/m² |
| Second tie layer | Escorene ™ FL00728EL | 6 | g/m² |
| Welding layer | HIPS 3630 | 3 | g/m² |

Nucrel® 0609 HSA is a trade name as marketed by Dupont and consists essentially of a copolymer of ethylene and methacrylic acid made with nominally 6.5 wt % methacrylic acid.

Lotader® 4503 is a trade name as marketed by Lotader and consists essentially of a random terpolymer of ethylene, acrylic ester and maleic anhydride, polymerized by high-pressure autoclave process.

HIPS 3630 is a polystyrene grade as marketed by Total and consists essentially of an easy flowing, medium impact polystyrene.

Escor™ 5110 and Escorene™ FL00728EL are as described previously.

Each sheet laminate was then subjected to qualitative tests including a friction test, a vacuum test, and a peel test. Sheet laminate #1 and #2 were manufactured with success and have almost similar properties; however, sheet laminate #2 appeared to perform slightly better. Further tests with sheet laminate #2 were conducted as outlined in the following.

Five sample sheet laminates #1 to #5 were produced using different temperature profiles with the material combination of sheet laminate #2 above. The below table shows the temperatures in ° C. that were applied during manufacture of the respective sample sheet laminate. The temperatures of the tie layer and the welding layer in the feed block and in the nozzle were the same, as seen from the tables below.

### Sample Sheet Laminate #1

| | Tie layer | Welding layer |
|---|---|---|
| Feed zone | 115 | 160 |
| Transition zone | 160 | 220 |
| Metering/Mixing zone | 190 | 220 |

| | |
|---|---|
| Feed block | 220 |
| Nozzle | 220 |

### Sample Sheet Laminate #2

| | Tie layer | Welding layer |
|---|---|---|
| Feed zone | 115 | 160 |
| Transition zone | 140 | 200 |
| Metering/Mixing zone | 170 | 200 |

| | |
|---|---|
| Feed block | 200 |
| Nozzle | 200 |

### Sample Sheet Laminate #3

| | Tie layer | Welding layer |
|---|---|---|
| Feed zone | 160 | 200 |
| Transition zone | 190 | 250 |
| Metering/Mixing zone | 240 | 260 |

| | |
|---|---|
| Feed block | 260 |
| Nozzle | 260 |

### Sample Sheet Laminate #4

| | Tie layer | Welding layer |
|---|---|---|
| Feed zone | 160 | 200 |
| Transition zone | 190 | 250 |
| Metering/Mixing zone | 260 | 280 |

| | |
|---|---|
| Feed block | 280 |
| Nozzle | 280 |

### Sample Sheet Laminate #5

| | Tie layer | Welding layer |
|---|---|---|
| Feed zone | 120 | 175 |
| Transition zone | 170 | 230 |
| Metering/Mixing zone | 220 | 240 |

| | |
|---|---|
| Feed block | 240 |
| Nozzle | 240 |

Each sample sheet laminate was subjected to three tests to examine the feasibility for production: a run-ability (or “manufacturability”) test, a sealing strength test and a vacuum test.

The run-ability test was performed by inspecting the melt curtain exiting the die when manufacturing each sample sheet laminate and the resulting distribution of coating after application. The sample laminate sheets were manufactured on a pilot line running at about 15% of a typical line speed of a production line. The line speed is the speed at which a production line produces a sheet laminate. The speed is generally given in meters per minute. The line speed of a production line may for instance be 300 meters per minute.

The melt curtain of the sample sheet laminate #1 as seen in FIG. 10 was somewhat uneven; however, the resulting coating was made successfully with uniform coating distribution on the base sheet layer.

The melt curtain of the sample sheet laminate #2 as seen in FIG. 11 was more uneven than that of sample sheet laminate #1. The resulting coating of the sample sheet laminate #2 was not produced with a uniform coating distribution on the entire surface of the base sheet layer. The uneven distribution of coating is reflected in the glossy areas on the surface of the sample sheet laminate #2 in FIG. 12. A good uniform distribution would have instead produced a uniform matt surface. It is expected that this is probably due to a too unstable melt and that with simple variations of, for instance the line speed, tie layer materials, and/or layer thickness, the a person skilled in the art would arrive at an acceptable coating distribution.

The melt curtain of the sample sheet laminates #3 and #4 as seen in FIGS. 13 to 14, respectively, appeared even, and the resulting coating distribution appeared uniform. During the manufacture of the sample sheet laminates #3 and #4 release of smoke was observed, which appeared to increase during manufacture of sample sheet laminate #4, and which may indicate degradation of the acid modified tie layer polymer. It is expected that with simple variations of, for instance the line speed, tie layer materials, and/or layer thickness, a person skilled in the art would be able to reduce the release of smoke and/or degradation to an acceptable level.

The melt curtain of the sample sheet laminate #5 appeared even and the resulting coating distribution appeared uniform without noticeable release of smoke.

The sealing strength test was performed by sealing the sample sheet laminates to a thick PS-film at 190° C. at 5 bar pressure for 0.5 seconds. The sealing strength was measured on a 15 mm wide strip and the results in Newtons are listed in the table below. The sealing strength was measured as the force needed per 15 mm to separate the layers from each other.

| Sample sheet | Sealing strength |
|---|---|
| laminate # | [N/15 mm] |
| 1 | 7.26 |
| 2 | 6.53 |
| 3 | 6.86 |
| 4 | 6.83 |
| 5 | 6.92 |

As seen from the table all sample sheet laminates had a sealing strength between 6.5 to 7.5, which all considered good. Furthermore, IR scans of the sealing zone were performed and all samples were peeled off and split substantially identically. The infrared scans of the sealing zone can be seen in FIG. 15, which shows five infrared spectroscopy scans, wherein the top row is an infrared spectroscopy scan of the sample sheet laminate #5, and the next four rows are infrared spectroscopy scans of the sample sheet laminates #1 to #4, respectively.

The vacuum tests were performed by sealing the sample sheet laminates to a polystyrene (PS) cup, at 190° C. at 2 bar pressure for 0.5 seconds. The sealed cups were put under three different vacuum pressures; a strict vacuum test of 0.30 bar, a moderate test of 0.25 bar, and a lenient test of 0.20 bar, and the time lapsed until the sealing broke is shown in the table below. When the time exceeded 40 seconds, the measurement was stopped, and 40< was noted in the table below.

| Sample sheet | 0.30 bar | 0.25 bar | 0.20 bar |
|---|---|---|---|
| laminate # | Time [s] | Time [s] | Time [s] |
| 1 | 1.2 | 1.5 | 40< |
| 2 | 1.9 | 40< | 40< |
| 3 | 35.8 | 40< | 40< |
| 4 | 2.0 | 40< | 40< |
| 5 | 35.0 | 40< | 40< |

The results show that the sample sheet laminates #3 and #5 last for 35.8 and 35.0 seconds, respectively, while the sample sheet laminates #1, #2 and #4 lasts below 2 seconds for strict vacuum test of 0.30 bar. This indicates for sample sheet laminates #1 and #2 that the coextrusion coating has lower adhesion and total strength due to lack of heat and inhomogeneous melt. Sample sheet laminate #4 also did not pass the strict vacuum test, indicating breakdown and decomposition of the polymers of the tie layers. It is expected that a person skilled in the art could, by simple variations of, for instance, the line speed, tie layer materials, layer thicknesses and/or by adding additives to the base sheet layer, the welding layer and/or the tie layer, arrive at a sealed cup which withstands a desired vacuum pressure for a desired amount of time. As seen from the table, different results were achieved when the vacuum pressure was varied. When performing the vacuum test at 0.20 bar all sample sheet laminates had improved performance.

What is claimed is:

1-26. (canceled)

27. A method for making a sheet laminate for being pre-punched to a sheet lid for a container, comprising:
providing a base sheet layer; and
coextrusion coating an additional sheet layer onto said base sheet layer, the additional sheet layer comprising at least one tie layer comprising polyolefin and a welding layer comprising at least 80% by weight polystyrene (PS), such that the at least one tie layer is disposed between the base sheet layer and the welding layer;
wherein a temperature of a welding layer material, the welding layer material being comprised in the welding layer in the sheet laminate, is kept below 275° C. during all parts of the coextrusion coating.

28. The method of claim 27, wherein the welding layer comprises at least 90% by weight polystyrene.

29. The method of claim 27, wherein the welding layer comprises at least 95% by weight polystyrene.

30. The method of claim 27, wherein the welding layer comprises substantially 100% by weight polystyrene.

31. The method of claim 27, wherein a content the polystyrene of the welding layer is at least 90% by weight.

32. The method of claim 27, wherein a temperature of the welding layer material is kept at or below a temperature of 260° C., during all parts of the coextrusion coating.

33. The method of claim 27, wherein each of the tie layer material and the welding layer material are fed into a feed block of an extruder through a respective separate feeder.

34. The method of claim 27, wherein the coextrusion coating is performed in an extruder comprising a feed zone, a transition zone, a metering/mixing zone, a feed block with a feed block zone, and a die; and
in which feed zone a temperature of a tie layer material, the tie layer material being comprised in the at least one tie layer of the sheet laminate, is 120 to 160° C.; and in which feed zone a temperature of a welding layer material, the welding layer material being comprised in the welding layer in the sheet laminate, is 175 to 200° C.; and
in which transition zone a temperature of a tie layer material, the tie layer material being comprised in the at least one tie layer of the sheet laminate, is 160 to 170° C.; and in which transition zone a temperature of a welding layer material, the welding layer material being comprised in the welding layer in the sheet laminate, is 230 to 250° C.; and
in which metering/mixing zone a temperature of a tie layer material, the tie layer material being comprised in the at least one tie layer of the sheet laminate, is 220 to 240° C.; and
in which metering/mixing zone a temperature of a welding layer material, the welding layer material being comprised in the welding layer in the sheet laminate, is 225 to 275° C.; and
in which feed block zone a temperature of a tie layer material, the tie layer material being comprised in the at least one tie layer of the sheet laminate, is 225 to 275° C., and in which feed block zone a temperature of a welding layer material, the welding layer material being comprised in the welding layer in the sheet laminate, is 225 to 275° C.; and
wherein a temperature of a welding layer material, the welding layer material being comprised in the welding layer in the sheet laminate, in the feed block being equal to or less than 10° C. from a temperature of a tie layer material in the die, and a temperature of a welding layer material, the welding layer material being comprised in the welding layer in the sheet laminate, in the die being equal to or less than 10° C. from a temperature of a tie layer material, the tie layer material being comprised in the at least one tie layer of the sheet laminate.

35. The method of claim 27, further comprising:
punching a sheet lid from the sheet laminate.

36. The method of claim 35, further comprising:
providing a container manufactured from PS or comprising an outer welding layer comprising PS;
subsequent to punching the sheet lid, arranging the sheet lid with a bottom surface of the welding layer thereof facing a welding surface of the container, said welding surface surrounding an opening of the container; and
welding the bottom surface of the welding layer of the punched sheet lid to the welding surface of the container.

37. A sheet laminate for being pre-punched to a sheet lid for a container, comprising:
a base sheet layer; and
an additional sheet layer comprising at least one tie layer comprising polyolefin and a welding layer comprising at least 80% by weight polystyrene (PS), the at least one tie layer being disposed between the base sheet layer and the welding layer;
wherein the additional sheet layer has been coextrusion coated onto said base sheet layer.

38. The method according to claim 27, wherein the magnitude of curl K of the sheet laminate measured according to ISO 11556:2005(E), second edition 2005, is equal to or less than 10 m⁻¹.

39. The sheet laminate according to claim 37, wherein no separate adhesive or glue layer, which includes a hardener or a hardening component, is provided between the additional sheet layer and the base sheet layer.

40. The sheet laminate of claim 37, wherein the magnitude of curl K of the sheet laminate measured according to ISO 11556:2005(E), second edition 2005, is equal to or less than 10 m⁻¹.

41. A laminated sheet lid for a container comprising:
a base sheet layer; and
an additional sheet layer comprising at least one tie layer comprising polyolefin and a welding layer comprising at least 80% by weight PS, the at least one tie layer being disposed between the base sheet layer and the welding layer;
wherein the additional sheet layer has been coextrusion coated onto said base sheet layer.

42. A package comprising a container with a sheet lid according to claim 41, wherein
the container is a PS container or comprises an outer welding layer comprising PS;
the sheet lid is arranged with the welding layer facing a welding surface of the container, said welding surface surrounding an opening of the container; and
a bottom welding surface of the welding layer of the punched sheet lid is welded to the welding surface of the container.

43. A method for making a sheet laminate for being pre-punched to a sheet lid for a container, comprising:
providing a base sheet layer; and
coextrusion coating an additional sheet layer onto said base sheet layer, the additional sheet layer comprising at least one tie layer comprising polyolefin and a welding layer comprising at least 80% by weight polystyrene (PS), such that the at least one tie layer is disposed between the base sheet layer and the welding layer;
wherein a styrene content in the polystyrene of the welding layer is at least 90% by weight.

44. The method of claim 43, wherein a temperature of a welding layer material, the welding layer material being comprised in the welding layer in the sheet laminate, is kept at or below a temperature of 260° C. during all parts of the coextrusion coating.

45. The method of claim 43, wherein each of the tie layer material and the welding layer material are fed into a feed block of an extruder through a respective separate feeder.

46. The method of claim 16, wherein the coextrusion coating is performed in an extruder comprising a feed zone, a transition zone, a metering/mixing zone, a feed block with a feed block zone, and a die, and
in which feed zone a temperature of a tie layer material, the tie layer material being comprised in the at least one tie layer of the sheet laminate, is 120 to 160° C.; and in which feed zone a temperature of a welding layer material, the welding layer material being comprised in the welding layer in the sheet laminate, is 175 to 200° C.; and
in which transition zone a temperature of a tie layer material, the tie layer material being comprised in the at least one tie layer of the sheet laminate, is 160 to 170° C.; and in which transition zone a temperature of a welding layer material, the welding layer material being comprised in the welding layer in the sheet laminate, is 230 to 250° C.; and
in which metering/mixing zone a temperature of a tie layer material, the tie layer material being comprised in the at least one tie layer of the sheet laminate, is 220 to 240° C.; and
in which metering/mixing zone a temperature of a welding layer material, the welding layer material being comprised in the welding layer in the sheet laminate, is 225 to 275° C.; and
in which feed block zone a temperature of a tie layer material, the tie layer material being comprised in the at least one tie layer of the sheet laminate, is 225 to 275° C., and in which feed block zone a temperature of a welding layer material, the welding layer material being comprised in the welding layer in the sheet laminate, is 225 to 275° C.; and
wherein a temperature of a welding layer material, the welding layer material being comprised in the welding layer in the sheet laminate, in the feed block being equal to or less than 10° C. from a temperature of a tie layer material in the die, and a temperature of a welding layer material, the welding layer material being comprised in the welding layer in the sheet laminate, in the die being equal to or less than 10° C. from a temperature of a tie layer material, the tie layer material being comprised in the at least one tie layer of the sheet laminate.
